(19) United States
(12) Patent Application Publication
(10) Pub. No.: US 2020/0130611 A1
(43) Pub. Date: Apr. 30, 2020

(54) COMPOSITE ARTICLES WITH A VARIABLE BASIS WEIGHT AND UNIFORM THICKNESS

(71) Applicants: Liqing Wei, Forest, VA (US); Ruomiao Wang, Forest, VA (US); Mark O. Mason, Forest, VA (US)

(72) Inventors: Liqing Wei, Forest, VA (US); Ruomiao Wang, Forest, VA (US); Mark O. Mason, Forest, VA (US)

(21) Appl. No.: 16/559,156

(22) Filed: Sep. 3, 2019

Related U.S. Application Data
(60) Provisional application No. 62/726,681, filed on Sep. 4, 2018.
(60) Provisional application No. 62/819,892, filed on Mar. 18, 2019.
(60) Provisional application No. 62/847,675, filed on May 14, 2019.

(51) Int. Cl. B60R 13/04; B32B 5/14; B32B 37/10; B32B 38/00

(52) U.S. Cl. CPC B60R 13/04; B32B 5/142; B32B 2307/73; B32B 38/164; B32B 2605/00; B32B 37/10

(57) ABSTRACT

Methods of producing core layers with a variable basis weight across a width of the core layer and with a substantially uniform thickness across the width of the core layer are described. The core layers can be used in wall panels such as those present in recreational vehicle panels. Systems and various materials used to produce the core layers and articles are also described.

### PRIORITY APPLICATIONS

This application claims priority to, and the benefit of, each of U.S. Provisional Application No. 62/726,681 filed on Sep. 4, 2018, U.S. Provisional Application No. 62/819,892 filed on Mar. 18, 2019, and U.S. Provisional Application No. 62/847,675 filed on May 14, 2019. The entire disclosure of each of these applications is hereby incorporated herein by reference for all purposes.

### TECHNOLOGICAL FIELD

Certain configurations described herein are directed to composite articles that comprise a variable basis weight at different areas of the core layer and which comprise a substantially uniform thickness.

### BACKGROUND

Composite articles have many different applications. Recreational vehicles often use composite articles in various applications.

### SUMMARY

Certain aspects, features, embodiments and examples of a core layer comprising a variable basis weight are described below. The core layer can be used in many different applications including, but not limited to, recreational vehicle panels, building products, furniture and other articles. The panel is typically used in an “as-produced” state and is not molded prior to use. Even though the core layer may comprise a variable basis weight at different areas, the thickness of the core layer can be substantially uniform, e.g., is the same or about the same across the width of the core layer.

In an aspect, a method of producing a recreational vehicle panel is described. In some embodiments, the method comprises disposing a dispersion comprising a substantially homogeneous mixture of a thermoplastic material and reinforcing fibers onto a forming support element, providing a pressure to less than an entire surface of the forming support element comprising the disposed foam to provide a porous web comprising a variable basis weight at different areas of the web, compressing the porous web comprising the variable basis weight at different areas of the web to a substantially uniform thickness across a width of the web, and drying the compressed web to provide a recreational vehicle panel comprising a porous core layer, wherein the recreational vehicle panel comprises a variable basis weight across a width of the porous core layer and comprises a substantially uniform thickness.

In some examples, the method comprises providing a negative pressure to an underside of the forming support element comprising the disposed dispersion. In other examples, the method comprises, providing the negative pressure to a central area of the forming support element comprising the disposed dispersion to provide the central area with a higher basis weight than at edges of the porous core layer. In some instances, the method comprises providing the negative pressure to an edge area of the forming support element comprising the disposed dispersion to provide the edge area with a higher basis weight than at a central area of the porous core layer. In some examples, the method comprises disposing a first skin on a first surface of the porous web prior to compressing the porous web. In other examples, the method comprises disposing a second skin on a second surface of the porous web prior to compressing the porous web. In additional examples, at least one of the first skin and the second skin comprises a variable basis weight. In some embodiments, at least one of the first skin and the second skin comprises a water repellent scrim. In other embodiments, each of the first skin and the second skin comprises a water repellent scrim. In some examples, each of the first skin layer and the second skin layer is coupled to the porous web without the use of an adhesive layer.

In another aspect, a recreational vehicle (RV) panel comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, and a second skin layer coupled to a second surface of the porous core layer.

In certain embodiments, the porous core layer comprises a lower basis weight at cross direction edges than at a central area. In some examples, the RV panel comprises a transition zone between each of the cross direction edges and the central area, wherein a basis weight of the transition zone is variable. In some embodiments, the transition zone comprises a basis weight/distance slope of greater than 0 gsm/cm and up to 100 gsm/cm. In some examples, the basis weight/distance slope is linear from the cross direction edges to the central area. In other examples, the reinforcing fibers comprise glass fibers. In certain examples, the thermoplastic material comprises a polyolefin material. In other examples, at least one of the first skin layer and the second skin layer comprises a water repellent scrim. In some embodiments, each of the first skin layer and the second skin layer comprises a water repellent scrim. In certain examples, each of the first skin layer and the second skin layer is coupled to the porous core layer without the use of an adhesive layer.

In an additional aspect, a recreational vehicle panel kit comprises a recreational vehicle panel comprising a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, and a second skin layer coupled to a second surface of the porous core layer, and written or electronic instructions for using the recreational vehicle panel to assemble a recreational vehicle wall.

In certain embodiments, the porous core layer comprises a lower basis weight at cross direction edges than at a central area. In other embodiments, the RV panel comprises a transition zone between each of the cross direction edges and the central area, wherein a basis weight of the transition zone is variable. In some examples, the transition zone comprises a basis weight/distance slope of greater than 0 gsm/cm and up to 100 gsm/cm. In other examples, the basis weight/distance slope is linear from the cross direction edges to the central area. In some examples, the reinforcing fibers comprise glass fibers. In other examples, the thermoplastic material comprises a polyolefin material. In certain examples, at least one of the first skin layer and the second skin layer comprises a water repellent scrim. In some examples, each of the first skin layer and the second skin layer comprises a water repellent scrim. In certain embodiments, each of the first skin layer and the second skin layer is coupled to the porous core layer without the use of an adhesive layer.

In another aspect, a wall panel comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, and a second skin layer coupled to a second surface of the porous core layer.

In certain examples, a difference in average basis weight at edges of the wall panel and a central area of the wall panel is at least 100 gsm. In other examples, the porous core layer comprises a lower basis weight at cross direction edges than at a central area. In some embodiments, the wall panel comprises a transition zone between each of the cross direction edges and the central area, wherein a basis weight of the transition zone is variable. In other instances, the transition zone comprises a basis weight/distance slope of greater than 0 gsm/cm and up to 100 gsm/cm. In some embodiments, the reinforcing fibers comprise glass fibers. In additional examples, the thermoplastic material comprises a polyolefin material. In some examples, at least one of the first skin layer and the second skin layer comprises a water repellent scrim. In certain embodiments, each of the first skin layer and the second skin layer comprises a water repellent scrim. In some examples, each of the first skin layer and the second skin layer is coupled to the porous core layer without the use of an adhesive layer.

In another aspect, a recreational vehicle wall comprises a first recreational vehicle panel comprising a first porous core layer comprising a web of open celled structures formed by the reinforcing fibers held together by the thermoplastic material, wherein the first porous core layer comprises a variable basis weight across a width of the first porous core layer and also comprises a substantially uniform thickness across the width of the porous core layer, a first skin layer coupled to a first surface of the first porous core layer, and a second skin layer coupled to a second surface of the first porous core layer. The RV wall may also comprise a second recreational vehicle panel comprising a second porous core layer comprising a web of open celled structures formed by the reinforcing fibers held together by the thermoplastic material, wherein the second porous core layer comprises a variable basis weight across a width of the second porous core layer and also comprises a substantially uniform thickness across the width of the porous core layer, a third skin layer coupled to a first surface of the second porous core layer of the, and a fourth skin layer coupled to a second surface of the second porous core layer.

In certain embodiments, a first edge of the first recreational vehicle panel comprises a lower basis weight than a first central area of the first recreational vehicle panel, wherein a first edge of the second recreational vehicle panel comprises a lower basis weight than a first central area of the first recreational vehicle panel, and wherein the first edge of the first recreational vehicle panel and the first edge of the second recreational vehicle panel are adjacent to each other in the recreational vehicle wall. In other embodiments, the porous core layer comprises a lower basis weight at cross direction edges than at a central area and wherein a basis weight difference at the cross direction edges and the central area is at least 100 gsm. In some examples, the RV wall comprises a transition zone between each of the cross direction edges and the central area, wherein a basis weight of the transition zone is variable. In some embodiments, the transition zone comprises a basis weight/distance slope of greater than 0 gsm/cm and up to 100 gsm/cm. In other embodiments, the reinforcing fibers comprise glass fibers. In certain examples, the thermoplastic material comprises a polyolefin material. In some examples, at least one of the first skin layer and the second skin layer comprises a water repellent scrim. In other examples, each of the first skin layer and the second skin layer comprises a water repellent scrim. In some embodiments, each of the first skin layer and the second skin layer is coupled to the porous core layer without the use of an adhesive layer.

In another aspect, a recreational vehicle may comprise one or more of the RV walls described herein or one or more of the RV panels described herein or both.

In another aspect, a ceiling tile comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, and a second skin layer coupled to a second surface of the porous core layer.

In an additional aspect, a structural panel comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, and a second skin layer coupled to a second surface of the porous core layer.

In another aspect, a cubicle wall panel sized and arranged to couple to another cubicle wall panel comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, and a second skin layer coupled to a second surface of the porous core layer.

In an additional aspect, a vinyl siding panel comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, a second skin layer coupled to a second surface of the porous core layer, and a vinyl substrate coupled to the first skin layer and configured to couple to a non-horizontal surface of a building to retain the vinyl siding panel to the non-horizontal surface of a building.

In another aspect, a roofing panel comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, a second skin layer coupled to a second surface of the porous core layer, and a roofing substrate coupled to the first skin layer and configured to couple to a roof of a building to retain the roofing panel to the roof.

In an additional aspect, a roofing shingle comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, a second skin layer coupled to a second surface of the porous core layer, and a weatherproof roofing shingle substrate coupled to the first skin layer and configured to couple to a roofing panel of a building to provide a weatherproof roofing shingle over the roofing panel.

In another aspect, a recreational vehicle exterior panel comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, a second skin layer coupled to a second surface of the porous core layer, and a weatherproof exterior wall substrate coupled to first skin layer.

In an additional aspect, a recreational vehicle interior panel comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, a second skin layer coupled to a second surface of the porous core layer, and an interior wall substrate coupled to first skin layer.

In another aspect, an interior trim article comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, a second skin layer coupled to a second surface of the porous core layer, and an interior trim substrate coupled to the first skin layer.

In an additional aspect, a composite article comprises a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer, a first skin layer coupled to a first surface of the porous core layer, and a second skin layer coupled to a second surface of the porous core layer.

Additional aspects, embodiments, examples, and configurations are described in more detail below.

### BRIEF DESCRIPTION OF THE SEVERAL VIEWS OF THE DRAWINGS

Certain features, configurations, aspects and embodiments are described below with reference to the accompanying figures in which:

FIG. 1A is an illustration of a core layer comprising a variable basis weight across a width of the core layer and a substantially uniform thickness across the width, in accordance with some examples;

FIG. 1B is another illustration of a core layer comprising a variable basis weight across a width of the core layer and a substantially uniform thickness across the width, in accordance with some examples;

FIGS. 2A and 2B are graphs showing basis weight differences at different areas of the core layer and a substantially uniform thickness across a width of the core layer, in accordance with certain examples;

FIGS. 3A and 3B are graphs showing basis weight differences at different areas of the core layer and a substantially uniform thickness across a width of the core layer, in accordance with certain examples;

FIGS. 4A and 4B are graphs showing basis weight differences at different areas of the core layer and a substantially uniform thickness across a width of the core layer, in accordance with some embodiments;

FIGS. 5A and 5B are graphs showing basis weight differences at different areas of the core layer and a substantially uniform thickness across a width of the core layer, in accordance with some embodiments;

FIGS. 6A and 6B are graphs showing basis weight differences at different areas of the core layer and a substantially uniform thickness across a width of the core layer, in accordance with certain embodiments;

FIG. 7 is an illustration showing a core layer with transition zones of variable basis weight, in accordance with some examples;

FIGS. 8A and 8 B are illustrations showing a basis weigh profile of a core layer with transition zones of variable basis weight, in accordance with some examples;

FIG. 9 is an illustration of a core layer with a single edge of variable basis weight, in accordance with certain examples;

FIGS. 10A and 10 B are graphs showing a basis weight profile for a core layer with a single edge of variable basis weight and a substantially uniform thickness across a width of the core layer, in accordance with some examples;

FIGS. 11A and 11B are graphs showing a basis weight profile for a core layer with a single edge of variable basis weight and a substantially uniform thickness across a width of the core layer, in accordance with some examples;

FIGS. 12A and 12B are graphs showing a basis weight profile for a core layer with a single edge of variable basis weight and a substantially uniform thickness across a width of the core layer, in accordance with some examples;

FIG. 13 is an illustration showing an expanded view of a transition zone, in accordance with some embodiments;

FIGS. 14A and 14B are graphs showing a basis weight profile in a transition zone, in accordance with some examples;

FIGS. 15A and 15B are illustrations showing a core layer comprising apertures at the edges (15A) and center (15B), in accordance with some embodiments;

FIGS. 16A and 16B are illustrations showing a core layer comprising slots at the edges (16A) and center (16B), in accordance with some embodiments;

FIG. 17A is an illustration showing a core layer with an edge comprising a lower basis weight, in accordance with some examples;

FIG. 17B is an illustration showing a core layer with a transition zone and an edge comprising a lower basis weight, in accordance with some examples;

FIG. 17C is an illustration of a composite article comprising a core layer and a skin layer disposed on the core layer, in accordance with certain examples;

FIG. 17D is an illustration of a composite article comprising a core layer and two skin layers disposed on the core layer, in accordance with certain examples;

FIG. 17E is an illustration of a composite article comprising a core layer and a skin layer with a variable basis weight disposed on the core layer, in accordance with certain examples;

FIG. 17F is an illustration of a composite article comprising a core layer a skin layer disposed on the core layer and a decorative layer disposed on the skin layer, in accordance with certain examples;

FIG. 18 shows part of a system comprising a pressure head, in accordance with some examples;

FIG. 19 shows part of a system comprising a vacuum head, in accordance with some examples;

FIG. 20 shows part of a system comprising a vacuum head and a pressure head, in accordance with some examples;

FIG. 21 is an illustration of a support element that can be used to produce a prepreg, in accordance with some embodiments;

FIG. 22 is another illustration of a support element that can be used to produce a prepreg, in accordance with some embodiments;

FIG. 23 schematically shows a process of placing strips of material at a central area to provide a core layer with a variable basis weight, in accordance with some examples;

FIG. 24 is a side view of a support element with a boss, in accordance with some embodiments;

FIG. 25 is an illustration of a ceiling grid comprising ceiling tiles, in accordance with certain embodiments;

FIG. 26 is an illustration of a cubicle panel, in accordance with some embodiments;

FIGS. 27A and 27B are illustrations of a structural panel, in accordance with some examples;

FIG. 28 is an illustration of a wall panel, in accordance with some configurations;

FIG. 29 is an illustration of a siding panel, in accordance with certain embodiments;

FIG. 30 is an illustration of a roofing panel, in accordance with certain examples;

FIG. 31 is an illustration of a roofing shingle, in accordance with certain examples;

FIG. 32 is an illustration of an interior recreational vehicle wall, in accordance with some examples;

FIG. 33 is an illustration of an exterior recreational vehicle wall, in accordance with some examples;

FIG. 34 is an illustration of an interior trim piece, in accordance with some embodiments;

FIG. 35 is an illustration showing certain layers present in a recreational vehicle wall, in accordance with some examples;

FIG. 36 is an illustration showing the seams of two articles used to assemble a recreational vehicle wall, in accordance with some examples;

FIG. 37 is an illustration showing a skin disposed on a core layer, in accordance with some examples;

FIG. 38 is an illustration showing different areas of a composite article that were tested, in accordance with some examples; and

FIGS. 39A and 39B are graphs showing thickness across a width of test samples.

The skilled person in the art, given the benefit of this disclosure, will recognize the illustrations in the figures are provided merely for illustration purposes and are not intended to limit the dimensions, configurations, shapes and features of the technology described herein.

### DETAILED DESCRIPTION

Certain specific examples are described in reference to producing a core layer and/or composite articles including a core layer. Reference may be made to an underside, bottom, top, etc. The exact placement of any one component relative to an underside, bottom, top, etc. of a core layer may vary as desired. No particular orientation or arrangement of a component, structure, etc. is intended to be required unless otherwise stated.

In some examples, the core layers described herein can be used in sandwich panels such as, for example, those commonly present in recreational vehicle walls, wall panels, cubicles, building products, and other articles. As noted herein, the core layers (and any articles including the core layers) are typically not molded prior to use, though they can be molded to a desired shape if desired. In some examples, a thickness of the article is substantially constant or uniform, e.g., varies by less than 10% across a width or cross direction of the article, even though a basis weight at the edges may be more or less than a basis weight at the center of the board.

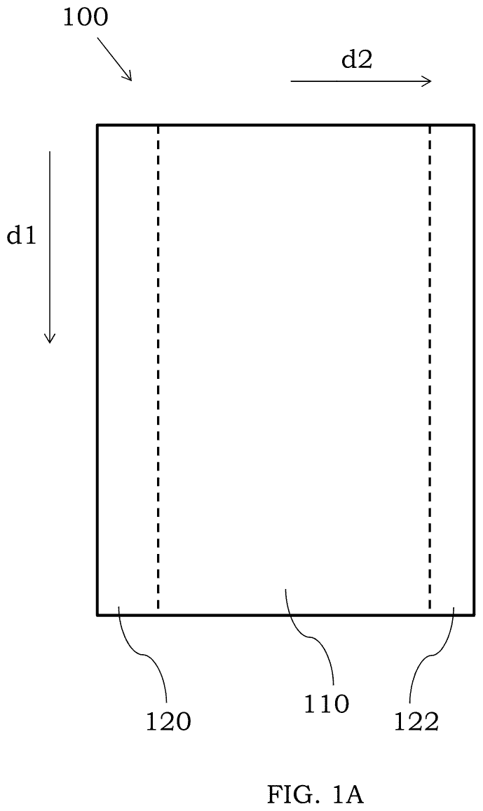

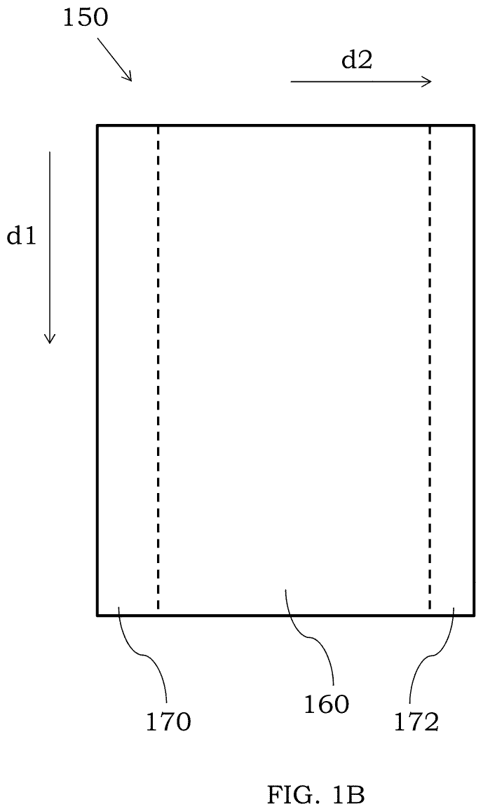

In certain embodiments, one or more edges of the core layers described herein may comprise a different basis weight than a central area of the core layer. Referring to FIG. 1A, an illustration of a core layer 100 with areas of varying or different basis weights is shown. The core layer 100 may comprise a central area 110 and edges 120, 122. A basis weight of the central area 110 can, on average, be higher than a basis weight at one or more of the edges 120, 122. In some examples, a basis weight of the central area 110 may be higher than at both edges 120, 122. For reference purposes, the direction d1 is generally referred to as the machine direction (MD) and the direction d2 is generally referred to as the cross direction (CD). If desired, edges in the cross direction d1 may also comprise a different basis weight or the same basis weight as at the central area 110 center of the core layer 100. Even though the edges 120, 122 may comprise a lower basis weight, a thickness of the core layer 100 is generally constant or substantially uniform.

In another configuration, one or more edges of a core layer may comprise a higher basis weight than a central area of the core layer. Referring to FIG. 1B, an illustration of a core layer 150 with areas of varying or different basis weights is shown. The core layer 150 may comprise a central area 160 and edges 170, 172. A basis weight of the central area 170 can, on average, be lower than a basis weight at one or more of the edges 170, 172. In some examples, a basis weight of the central area 160 may be lower than at both edges 170, 172. If desired, edges in the machine direction d1 may also comprise a different basis weight or the same basis weight as at a center area 160 of the core layer 150. Even though the edges 170, 172 may comprise a higher basis weight, a thickness of the core layer 100 is generally constant or substantially uniform.

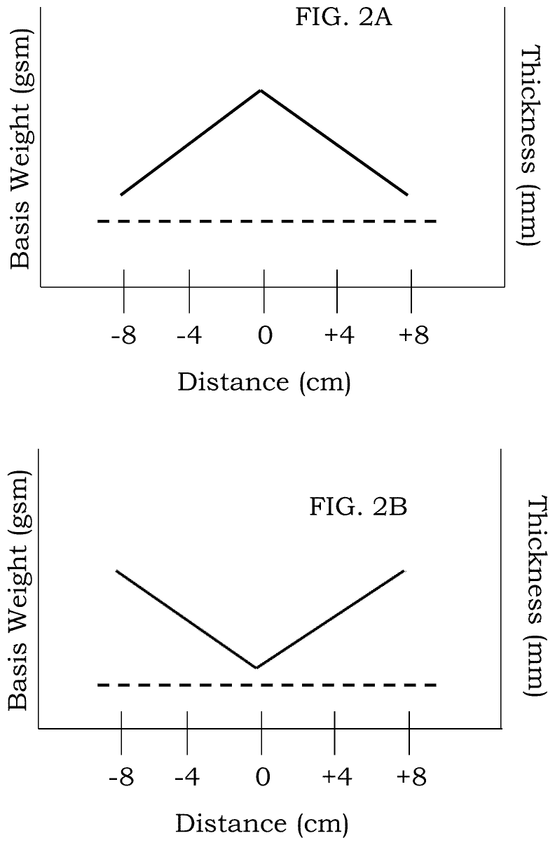

In some embodiments, the basis weight may be sloping from the central area to the edges of the core layer such that there is a gradual, e.g., linear or non-linear, decrease in the basis weight from a center of the core toward the edges. One configuration is illustrated graphically in FIG. 2A where the “0” position is the center of the core layer 100, the negative distance moves laterally in the cross direction d2 toward the edge 120, and the positive distance moves laterally in the cross direction d2 toward the edge 122. In this illustration, the basis weight decreases linearly from the center of the core to outer edges in a generally symmetric manner, e.g., the basis weight/distance slope is linear and substantially the same across the width of the core layer. If desired, however, the slope may be different from the center toward the edges of the core. Even though the edges may comprise a lower basis weight, a thickness of the core layer is generally constant or substantially uniform as shown by the dashed line in FIG. 2A. Another configuration is illustrated graphically in FIG. 2B where the “0” position is the center of the core layer 150, the negative distance moves laterally in the cross direction d2 toward the edge 170, and the positive distance moves laterally in the cross direction d2 toward the edge 172. In this illustration, the basis weight increases linearly from the center of the core to outer edges in a generally symmetric manner, e.g., the basis weight/distance slope is linear and substantially the same across the width of the core layer. If desired, however, the slope may be different from the center toward the edges of the core. Even though the edges may comprise a higher basis weight, a thickness of the core layer is generally constant or substantially uniform as shown by the dashed line in FIG. 2B.

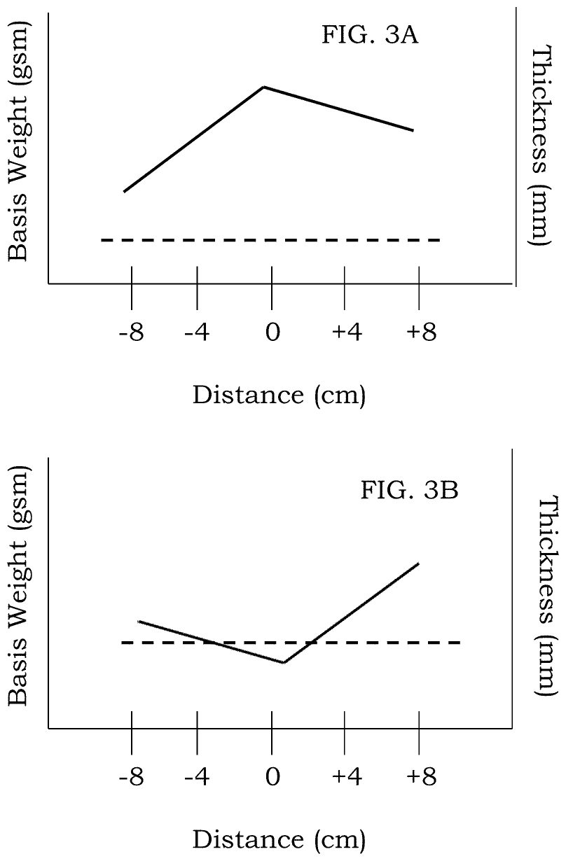

In another illustration as shown in FIG. 3A, the basis weight toward the edge 120 decreases more than a basis weight from the center toward the edge 122. Even though the edges may comprise a lower basis weight, a thickness of the core layer is generally constant or substantially uniform as shown by the dashed line in FIG. 3A. In FIG. 3B, a basis weight toward the edge 172 increases more than a basis weight from the center toward the edge 170. Other configurations are also possible, and in some instances the basis weight toward one edge may decrease compared to a basis weight at the center, and a basis weight toward another edge may increase compared to a basis weight at the center. Even though the edges may comprise a higher basis weight, a thickness of the core layer is generally constant or substantially uniform as shown by the dashed line in FIG. 3B.

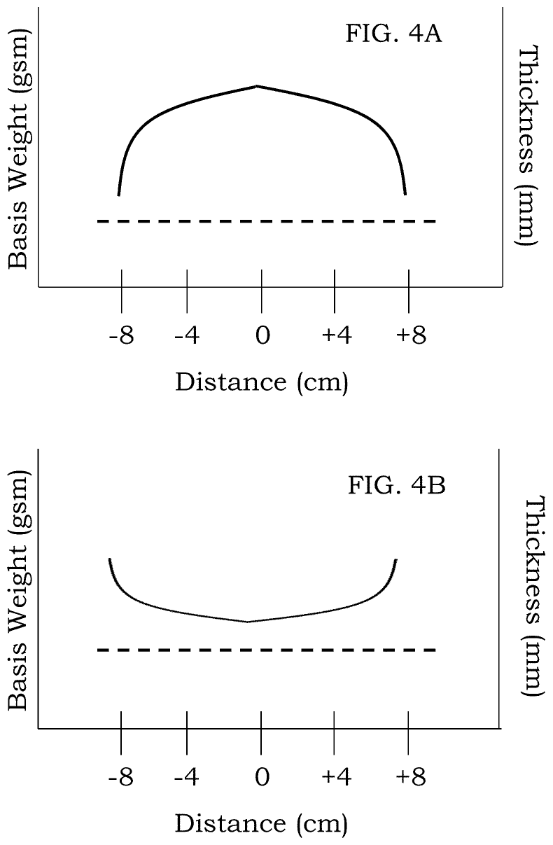

In certain examples, the change in basis weight need not be linear across the width of the core layer. Referring to FIG. 4A, a graph is shown where the basis weight across the width of the core layer decreases in a non-linear manner from the center toward the edges. In this illustration the basis weight drops sharply toward the outer portion of the edges of the core layer. Even though the edges may comprise a lower basis weight, a thickness of the core layer is generally constant or substantially uniform as shown by the dashed line in FIG. 4A. Referring to FIG. 4B, a graph is shown where the basis weight across the width of the core layer increases in a non-linear manner from the center toward the edges. In this illustration the basis weight increases sharply toward the outer portion of the edges of the core layer. Non-linear and asymmetric decreases or increases are also possible. Even though the edges may comprise a higher basis weight, a thickness of the core layer is generally constant or substantially uniform as shown by the dashed line in FIG. 4B.

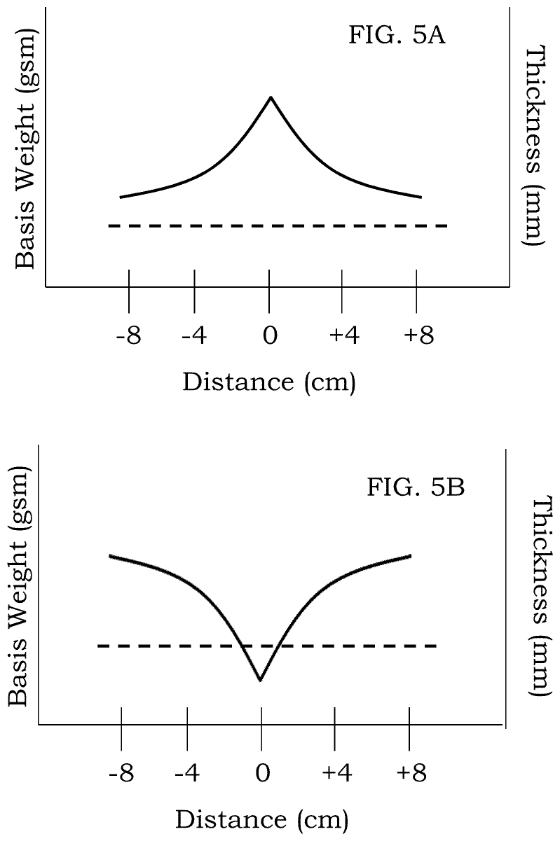

Another illustration of a non-linear decrease in basis weight from a center of a core layer to edges of a core layer is shown in FIG. 5A. In this illustration, the basis weight decreases quickly moving away from the center and levels off toward the edges of the core layer. Even though the edges may comprise a lower basis weight, a thickness of the core layer is generally constant or substantially uniform as shown by the dashed line in FIG. 5A. Referring to FIG. 5B, an illustration of a non-linear increase in basis weight from a center of a core layer to edges of a core layer is shown. In this illustration, the basis weight increases quickly moving away from the center and levels off toward the edges of the core layer. Even though the edges may comprise a higher basis weight, a thickness of the core layer is generally constant or substantially uniform as shown by the dashed line in FIG. 5B.

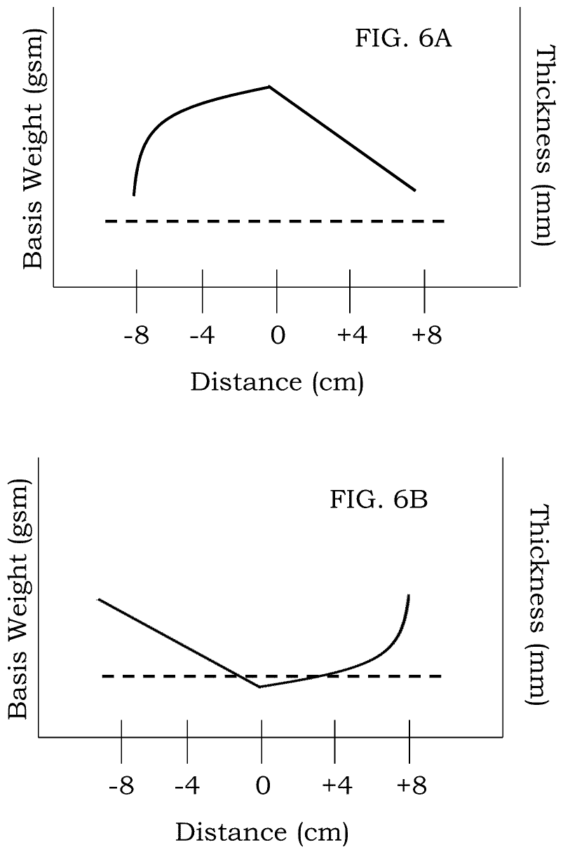

An additional illustration is shown in FIG. 6A, where a decrease in basis weight is non-linear in one direction toward one edge of the core layer, and a decrease in basis weight is linear in another direction toward another edge of the core layer. If desired, different non-linear decreases in basis weight from the center the edges of the core layer may also be present. Even though the edges may comprise a lower basis weight, a thickness of the core layer is generally constant or substantially uniform as shown by the dashed line in FIG. 6A. Referring to FIG. 6B, an increase in basis weight is non-linear in one direction toward one edge of the core layer, and an increase in basis weight is linear in another direction toward another edge of the core layer. If desired, different non-linear increases in basis weight from the center the edges of the core layer may also be present. Even though the edges may comprise a higher basis weight, a thickness of the core layer is generally constant or substantially uniform as shown by the dashed line in FIG. 6B.

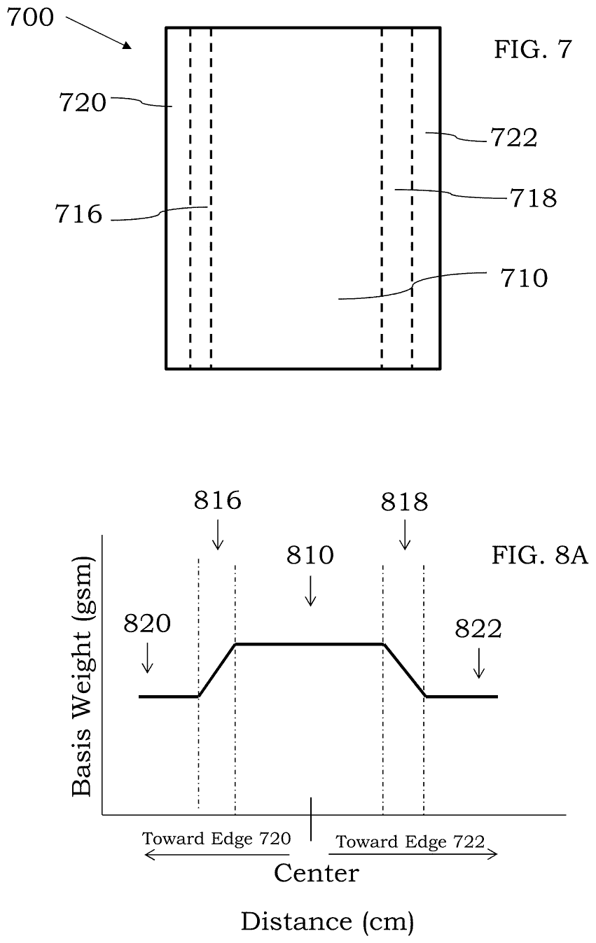

In certain embodiments, the basis weight decrease or increase from center to edge of the core layer may also comprise one or more transition areas or zones. Referring to FIG. 7, a core layer 700 is shown comprising a central area 710, transition zones 716, 718 and edges 720, 722. In some examples, a basis weight of the central area 110 may be substantially constant across the width of the board, e.g., across the cross direction. A basis weight can then decrease (or increase) in the transition zones 716, 718 moving toward the edges 720, 722, respectively. The basis weight at the edges 720, 722 may be substantially constant. As noted herein, the thickness across the width of the core layer 700 may be constant or substantially uniform.

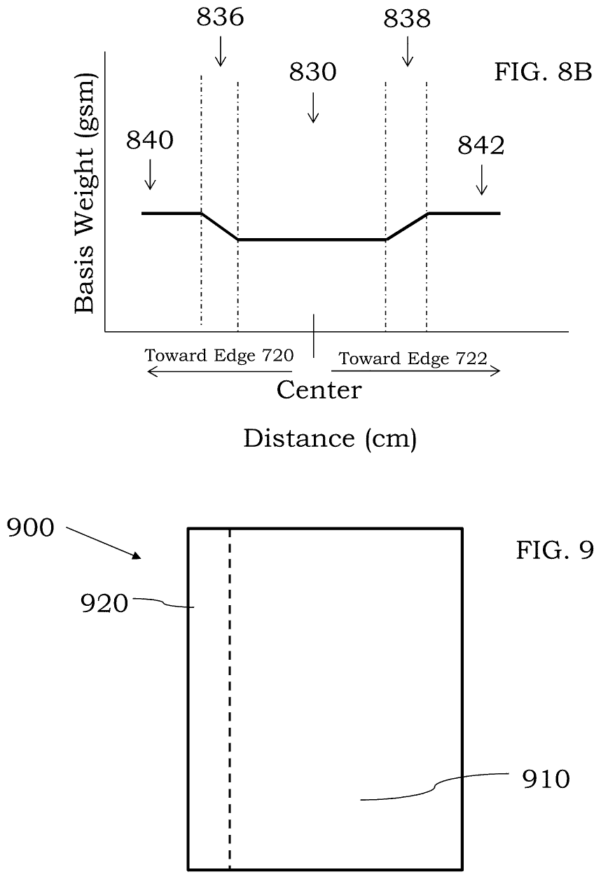

One graphical illustration of a configuration where basis weight decreases toward the edges is shown in FIG. 8A where “0” marks a center position of the core layer of FIG. 7. A basis weight across the central area 710 is shown as area 810, a basis weight across the edges 720, 722 is shown as areas 820, 822, respectively, and the basis weight in the transition zones 716, 718 is shown as areas 816, 818. In some examples, the basis weight in the transition zones may decrease by about 1 gsm/cm to about 100 gsm/cm, more particularly a decrease of about 10 gsm/cm to about 80 gsm/cm in the transition zones 716, 718. The decrease in basis weight in the transition zone 716 need not be the same as the decrease in basis weight in the transition zone 718. Further, the basis weight in one of the transition zones 716, 718 may decrease linearly, and the basis weight in the other one of the transition zones 716, 718 may decrease in a non-linear manner.

A graphical illustration of a configuration where basis weight increases toward the edges is shown in FIG. 8B where “0” marks a center position of the core layer of FIG. 7. A basis weight across the central area 710 is shown as area 830, a basis weight across the edges 720, 722 is shown as areas 840, 842, respectively, and the basis weight in the transition zones 716, 718 is shown as areas 836, 838. In some examples, the basis weight in the transition zones may increase by about 1 gsm/cm to about 100 gsm/cm, more particularly an increase of about 10 gsm/cm to about 80 gsm/cm in the transition zones 716, 718. The increase in basis weight in the transition zone 716 need not be the same as the increase in basis weight in the transition zone 718. Further, the basis weight in one of the transition zones 716, 718 may increase linearly, and the basis weight in the other one of the transition zones 716, 718 may increase in a non-linear manner. In some examples, only a single transition zone may be present in a core layer. For example, where the core layer is used in a composite article configured as a recreational vehicle panel, it may only be desirable to have a lower basis weight at a single edge Referring again to FIG. 7, a basis weight in the central area 710 can be substantially constant across the cross direction of the central area 710. Similarly, a basis weight in the edges 720, 722 can be substantially constant across the cross direction.

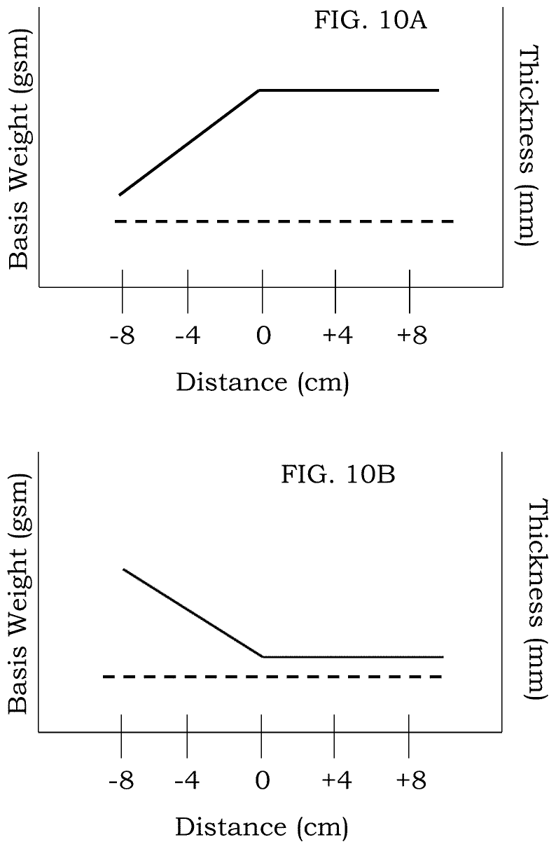

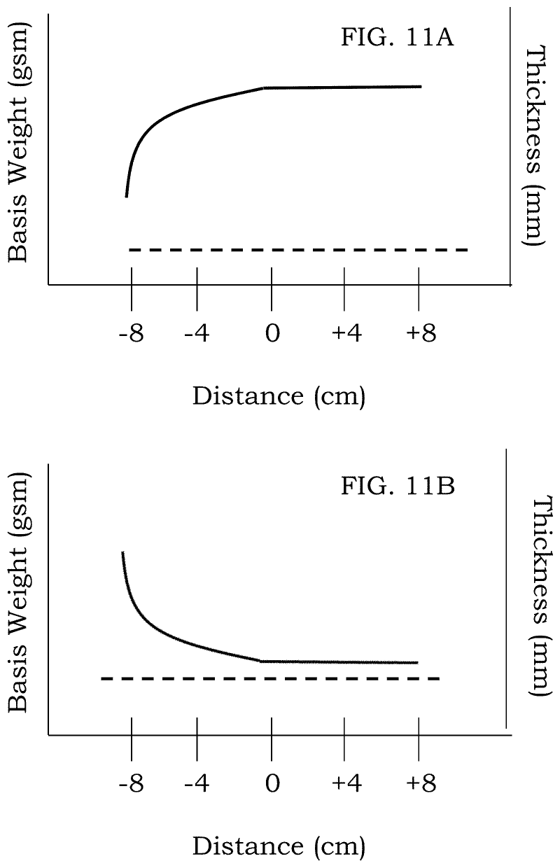

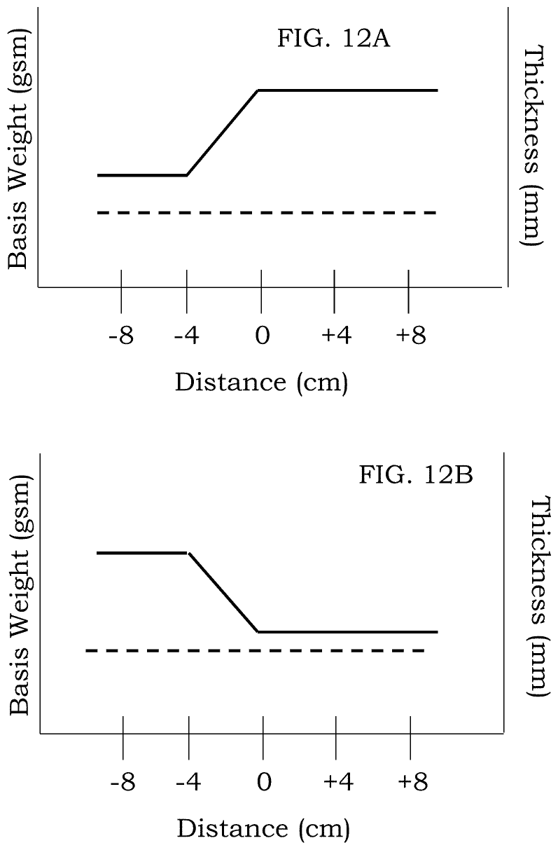

In certain configurations, it may be desirable to configure a core layer where only one edge of the core layer comprises a different basis weight than a central area. Referring to FIG. 9, a core layer 900 is shown that comprises a central area 910 and an edge 920 with a different basis weight than a basis weight of the central area 910. In some instances, a basis weight of the central area 910 can, on average, be higher than a basis weight at the edge 920. In other instances, a basis weight of the central area 910 can, on average, be lower than a basis weight at the edge 920. As noted herein, the thickness across the pore layer 900 may be constant or substantially uniform. Several of many different possibilities for different basis weight profiles of the core layer 910 are shown graphically in FIGS. 10A-12B. Referring to FIG. 10A, a basis weight profile is shown where the basis weight of the central area 910 is substantially constant, and moving toward the edge 920 provides a linear decrease in basis weight. The thickness is constant or substantially uniform as shown by the dashed line in FIG. 10A. Referring to FIG. 10B, a basis weight profile is shown where the basis weight of the central area 910 is substantially constant, and moving toward the edge 920 provides a linear increase in basis weight. The thickness is constant or substantially uniform as shown by the dashed line in FIG. 10B. Referring to FIG. 11A, a basis weight profile is shown where the basis weight of the central area 910 is substantially constant, and moving toward the edge 920 provides a non-linear decrease in basis weight. The thickness is constant or substantially uniform as shown by the dashed line in FIG. 11A. Referring to FIG. 11B, a basis weight profile is shown where the basis weight of the central area 910 is substantially constant, and moving toward the edge 920 provides a non-linear increase in basis weight. The thickness is constant or substantially uniform as shown by the dashed line in FIG. 11B. Referring to FIG. 12A, a basis weight profile is shown where there is a stepped basis weight change, e.g., as might be present where a transition zone exists between the central area 910 and the edge 920. In this configuration, the basis weight drops linearly (though it may drop non-linearly in the transition zone if desired) and then levels off to be substantially constant at the edge 920. The thickness is constant or substantially uniform as shown by the dashed line in FIG. 12A. Referring to FIG. 12B, a basis weight profile is shown where there is a stepped basis weight change, e.g., as might be present where a transition zone exists between the central area 910 and the edge 920. In this configuration, the basis weight increases linearly (though it may increase non-linearly in the transition zone if desired) and then levels off to be substantially constant at the edge 920. The thickness is constant or substantially uniform as shown by the dashed line in FIG. 12B. Other basis weight profiles will be recognized by the skilled person, given the benefit of this disclosure.

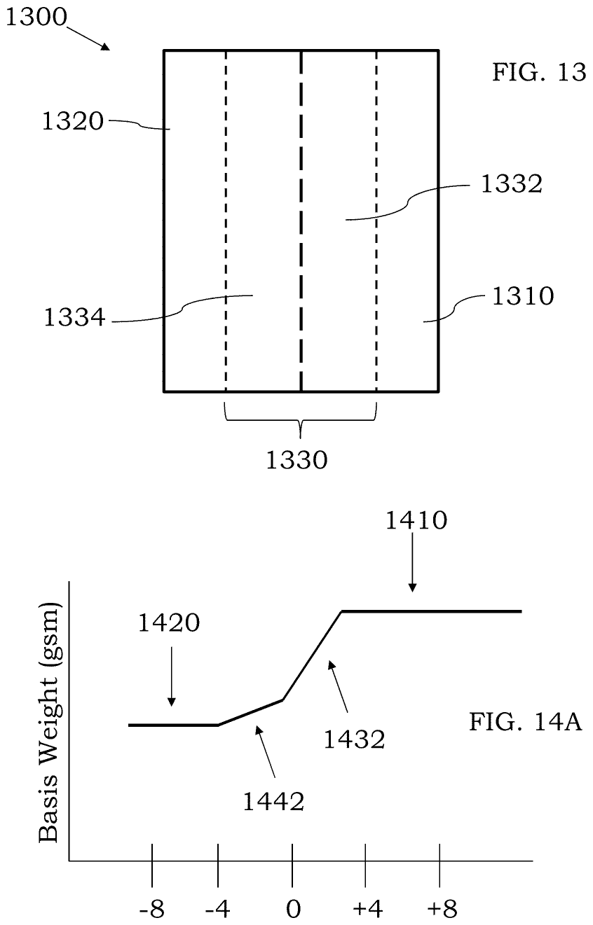

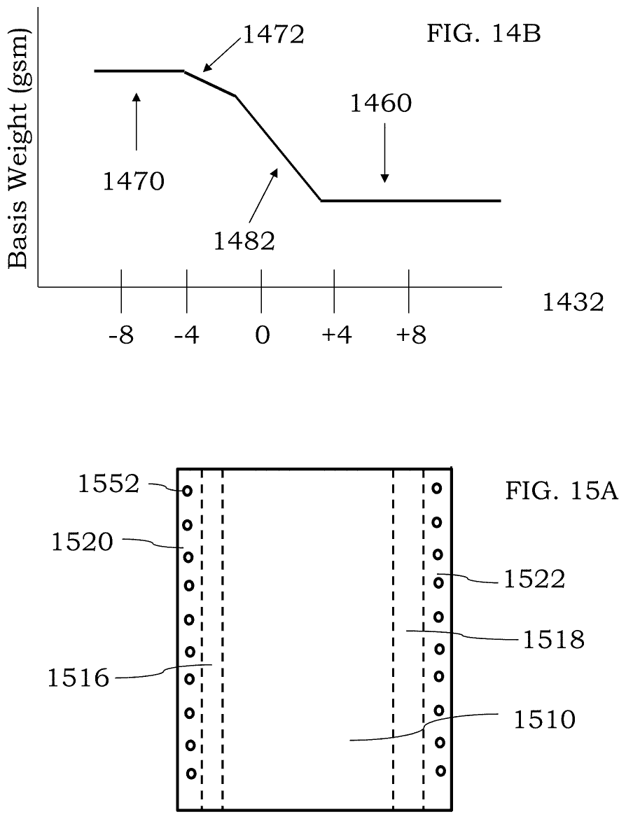

In some embodiments, the transition zone may comprise more than a single zone or region. Referring to FIG. 13, an expanded view of a transition zone or region 1330 is shown that comprises areas 1332, 1334. A central region 1310 is shown being positioned adjacent to the transition region 1332. The change in basis weight in the transition regions 1332, 1334 need not be the same. For example and referring to FIG. 14A, a basis weight 1410 of the region 1310 and a basis weight 1420 of the region 1320 are substantially constant. A basis weight 1432 of the transition region 1332 decreases by a larger slope than a basis weight 1442 of the transition region 1334. While linear decreases in basis weight are shown in FIG. 14A for the transition regions 1332, 1334, the basis weight in one or both of the transition regions 1332, 1334 could be non-linear. Referring to FIG. 14B, a basis weight 1460 of the region 1310 and a basis weight 1470 of the region 1320 are substantially constant. A basis weight 1482 of the transition region 1332 increases by a larger slope than a basis weight 1472 of the transition region 1334. While linear increases in basis weight are shown in FIG. 14B for the transition regions 1332, 1334, the basis weight in one or both of the transition regions 1332, 1334 could be non-linear. While not shown, the thickness across the core layer 1300 can be constant or substantially uniform.

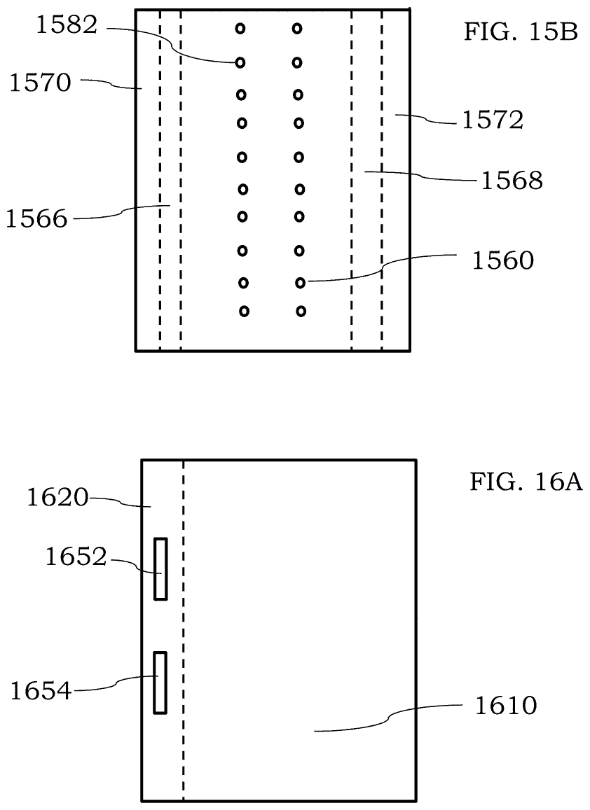

In certain configurations, it may be desirable to have a decreased basis weight at the edges of a core layer and/or composite article comprising the core layer by intentionally including perforations, slits, holes or the like at the edges. One illustration is shown in FIG. 15 where a core layer comprises a central area 1510, transition regions 1516, 1518 and side edges 1520, 1522. Each of the side edges is shown as comprising a plurality of apertures to reduce the average basis weight at the edges 1520, 1522. For example, aperture 1552 is shown as being positioned at the edge 1520. Alternatively, perforations, slits, holes or the like can be present at the central area such that an average basis weight at the central area is lower than the edges. Referring to FIG. 15B, a core layer comprises a central area 1560, transition regions 1566, 1568 and side edges 1570, 1572. The central area 1560 is shown as comprising a plurality of apertures to reduce the average basis weight at the central area 1560. For example, aperture 1582 is shown as being positioned within the central area 1560. While two edges of variable basis weight are shown in FIGS. 15A and 15B, a core layer comprising only a single edge of differing basis weight and with apertures (either at the edges or within a central area or both) may be present. Similarly, no transition zones or areas may be present if desired. The apertures shown in FIGS. 15A and 15B are merely illustrative and different apertures may comprise different shapes and sizes. Further, the exact number of apertures present may vary and the edges need not have the same number of apertures. In general, the apertures provide open space, permit gases to flow through the core layer and can reduce basis weight at certain areas. The presence of apertures can provide desirable attributes including, for example, the ability to produce a core layer with a substantially similar basis weight across the thickness of the core layer and then alteration of the basis weight at the edges by providing the apertures. Alternatively, as noted below, the apertures can be formed in an inline process during formation of the core layer without the need for any post-formation processing to form the apertures. The exact number of apertures present in the edges or the central area may vary, and the apertures may be replaced with, or used in combination with, slots, slits, perforations, etc. While not shown, the thickness across a core layer comprising apertures can be constant or substantially uniform.

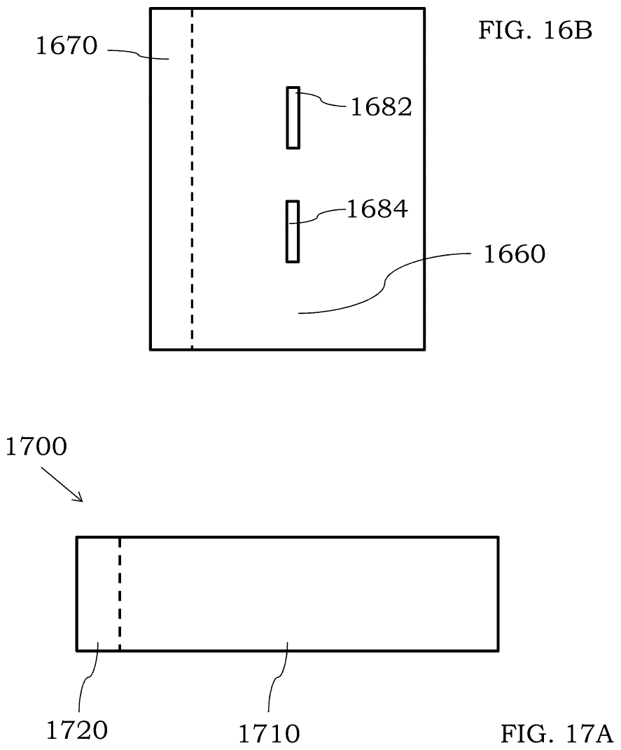

In another instance, one or more slots can be present in an edge of a core layer or at a central area to provide an edge or central area with an average basis weight that is lower. Referring to FIG. 16A, a core layer is shown that comprise a central area 1610, an edge 1620 and slots 1652, 1654 in the edge 1620. The presence of the slots 1652, 1654 reduces the average basis weight at the edge 1620. The basis weight at the central area 1610 is generally higher than the average basis weight at the edge 1620. The exact number of slots present in the edge 1620 may vary, and the slots may be replaced with, or used in combination with, apertures, slits, perforations, etc. While not shown, the thickness across a core layer comprising a slot can be constant or substantially uniform.

Referring to FIG. 16B, a core layer is shown that comprise a central area 1660, an edge 1670 and slots 1682, 1684 in the central area 1660. The presence of the slots 1682, 1684 reduces the average basis weight at the edge 1670. The basis weight at the central area 1660 is generally higher than the average basis weight at the edge 1670. The exact number of slots present in the edge 1670 may vary, and the slots may be replaced with, or used in combination with, apertures, slits, perforations, etc. While not shown, the thickness across a core layer comprising a slot can be constant or substantially uniform.

In some examples, the exact basis weight difference between the edges and central area may vary depending on the intended or final use of the article. In some examples, a basis weight difference between an edge and a central area may be up to about 100 gsm. In other examples, a basis weight difference between an edge and a central area may be up to about 90 gsm. In some examples, a basis weight difference between an edge and a central area may be up to about 80 gsm. In some examples, a basis weight difference between an edge and a central area may be up to about 70 gsm. In other examples, a basis weight difference between an edge and a central area may be up to about 60 gsm. In some examples, a basis weight difference between an edge and a central area may be up to about 50 gsm. In some examples, a basis weight difference between an edge and a central area may be up to about 40 gsm. In other examples, a basis weight difference between an edge and a central area may be up to about 30 gsm. In some examples, a basis weight difference between an edge and a central area may be up to about 20 gsm. In some examples, a basis weight difference between an edge and a central area may be up to about 15 gsm. In other examples, a basis weight difference between an edge and a central area may be up to about 10 gsm. In some examples, a basis weight difference between an edge and a central area may be up to about 5 gsm.

In certain embodiments, the core layers described herein generally comprise one or more thermoplastic materials and one or more reinforcing fiber materials. The core layer may first be formed as a prepreg which is generally a precursor to the core layer and is not necessarily fully formed. For ease of illustration, a core layer is described below, though the properties of the core layer may also be the same as a prepreg. The core layer is typically a porous structure to permit gases to flow through the core layer. For example, the core layer may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. In some instances, the core layer comprises a porosity or void content of greater than 0%, e.g., is not fully consolidated, up to about 95%. Unless otherwise stated, the reference to the core layer comprising a certain void content or porosity is based on the total volume of the core layer and not necessarily the total volume of the core layer plus any other materials or layers coupled to the core layer.

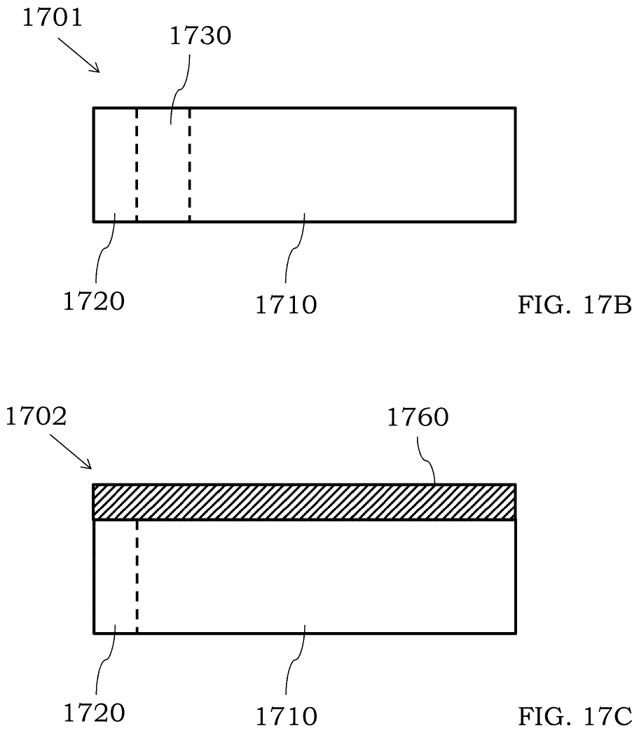

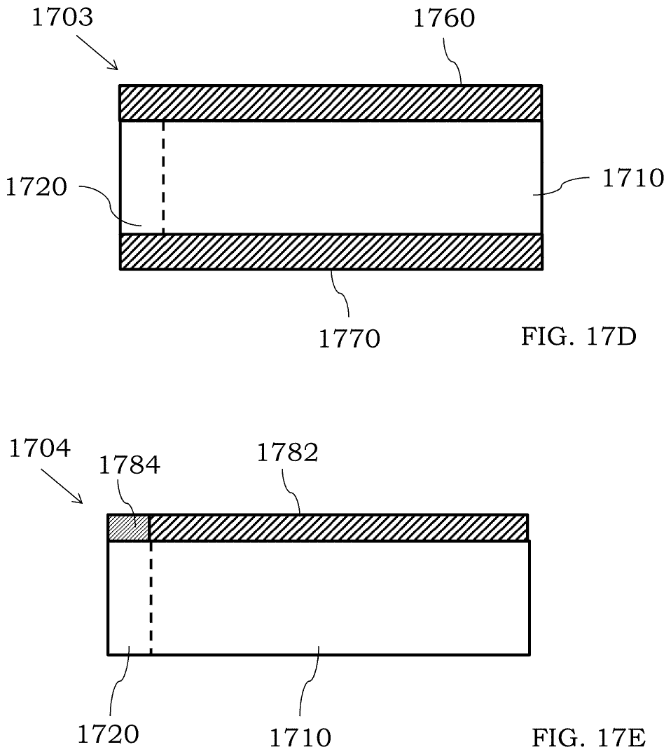

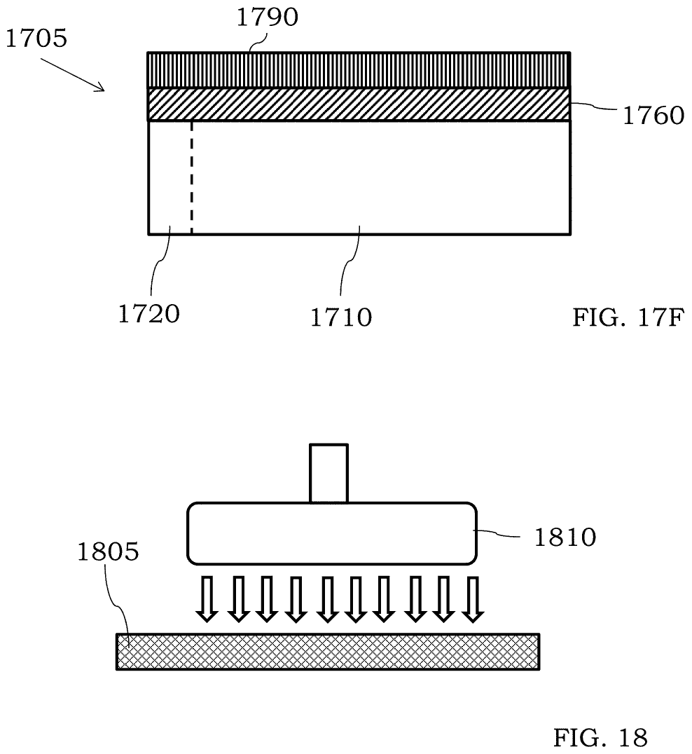

In some examples, a web formed from random crossing over of the reinforcing fibers held together by the thermoplastic material may be present in the core layer. A side view of one illustration of a core layer is shown in FIG. 17A. The core layer 1700 generally comprises a planar layer that can be subjected to additional processing, e.g., molding, thermoforming, drawing, etc. to provide non-planar structures. The core layer 1700 may comprise a central area 1710 with a first average basis weight and an edge 1720 with a second average basis weight. In some examples, the first average basis weight is greater than the second average basis weight. In other examples, the first average basis weight is less than the second average basis weight. While not wishing to be bound by any particular ranges, the first average basis weight may vary from around 500 gsm to about 2000 gsm, more particularly about 1000 gsm to about 1500 gsm. The second average basis weight may vary from around 400 gsm to about 1800 gsm, more particularly around 900 gsm to about 1500 gsm. If desired, an average basis weight at the edge 1720 may be at least 5% less than an average basis weight at the central area 1710, or an average basis weight at the edge 1720 may be least 10% less or at least 15% less or at least 20% less than an average basis weight at the central area 1710. The edge 1720 and the central area 1710 may comprise the same or different materials or one common material but a second different material, e.g., a common thermoplastic material but different reinforcing fibers. In some instances, the edge 1720 and the central area 1710 comprise the same materials but in differing amounts so the average basis weight of the edge 1720 is less than an average basis weight of the central area 1710. In other instances, the edge 1720 and the central area 1710 may comprise about the same amount of thermoplastic material and reinforcing fibers, but the central area can also comprise additional materials, e.g. lofting agents such as expandable microspheres, flame retardants, additional fibers, etc. to increase the overall average basis weight of the central area 1710. In some examples, the edge 1720 and the central area 1710 comprise the same materials but in differing amounts so the average basis weight of the edge 1720 is greater than an average basis weight of the central area 1710. In other instances, the edge 1720 and the central area 1710 may comprise about the same amount of thermoplastic material and reinforcing fibers, but the central area can also comprise additional materials, e.g. lofting agents such as expandable microspheres, flame retardants, additional fibers, etc. to increase the overall average basis weight of the edge 1720. As described above, the basis weight of the edge 1720 may be substantially constant or may vary moving from the central area toward an outer portion of the edge 1720. In some examples, the thickness across the core layer 1700 can be constant or substantially uniform.

In certain examples and referring to FIG. 17B, another illustration of a core layer 1701 is shown where the core layer 1701 comprises a central area 1710, an edge 1720 and a transition zone or region 1730 between the edge 1720 and the central area 1710. As noted herein, the transition zone or region 1730 may be present with a decreasing or increasing basis weight moving from the central area 1710 toward the edge 1710. An average basis weight of the edge 1720 may be substantially constant across the width of the edge 1720 or may be variable. In some examples, the thickness across the core layer 1701 can be constant or substantially uniform.

In certain embodiments, the thermoplastic material of the core layers described herein may comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. The virgin thermoplastic material used to form the core layer can be used in powder form, resin form, rosin form, fiber form or other suitable forms. Illustrative thermoplastic materials in various forms are described herein and are also described, for example in U.S. Publication Nos. 20130244528 and US20120065283. The exact amount of thermoplastic material present in the core layer can vary and illustrative amounts range from about 20% by weight to about 80% by weight. In some instances, the thermoplastic material loading rate may be lower at an edge or edges of the core layer to provide a lower basis weight at the edge or edges of the core layer. While not required, a polyolefin can be present in the core layer and softened during production to enhance mechanical bonding of the core layer to other layers of the article.

In certain examples, the reinforcing fibers of the core layer described herein can comprise glass fibers, carbon fibers, graphite fibers, synthetic organic fibers, particularly high modulus organic fibers such as, for example, para- and meta-aramid fibers, nylon fibers, polyester fibers, or any high melt flow index resins that are suitable for use as fibers, natural fibers such as hemp, sisal, jute, flax, coir, kenaf and cellulosic fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some instances, one type of the reinforcing fibers may be used along with mineral fibers such as, for example, fibers formed by spinning or drawing molten minerals. Illustrative mineral fibers include, but are not limited to, mineral wool fibers, glass wool fibers, stone wool fibers, and ceramic wool fibers. In some embodiments, any of the aforementioned fibers can be chemically treated prior to use to provide desired functional groups or to impart other physical properties to the fibers. The total fiber content in the core layer may be from about 20% to about 90% by weight of the core layer, more particularly from about 30% to about 70%, by weight of the core layer. Typically, the fiber content of a composite article comprising the core layer varies between about 20% to about 90% by weight, more particularly about 30% by weight to about 80% by weight, e.g., about 40% to about 70% by weight of the composite. The particular size and/or orientation of the fibers used may depend, at least in part, on the polymer material used and/or the desired properties of the resulting core layer. Suitable additional types of fibers, fiber sizes and amounts will be readily selected by the person of ordinary skill in the art, given the benefit of this disclosure. In one non-limiting illustration, fibers dispersed within a thermoplastic material to provide a core layer generally have a diameter of greater than about 5 microns, more particularly from about 5 microns to about 22 microns, and a length of from about 5 mm to about 200 mm. More particularly, the fiber diameter may be from about microns to about 22 microns and the fiber length may be from about 5 mm to about 75 mm. In some configurations, the flame retardant material may be present in fiber form. For example, the core layer may comprise a thermoplastic material, reinforcing fibers and fibers comprising a flame retardant material, e.g., fibers comprising an EG material or an inorganic flame retardant material. The flame retardant fibers may comprise any one or more of the flame retardant materials described herein, e.g., polypropylene fibers compounded with a hydroxide material which is then extruded and cut into fibers using a suitable die or other devices, or EG materials mixed with polypropylene fibers compounded with a hydroxide material which is then extruded and cut into fibers using a suitable die or other devices. In some instances, the reinforcing fiber loading rate may be lower at an end or edges of the core layer to provide a lower basis weight at the edge or the edges.

In some configurations, the core layer may be a substantially halogen free or halogen free layer to meet the restrictions on hazardous substances requirements for certain applications. In other instances, the core layer may comprise a halogenated flame retardant agent (which can be present in the flame retardant material or may be added in addition to the flame retardant material) such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the core layers may comprise one or more halogens to impart some flame retardancy without the addition of another flame retardant agent. For example, the thermoplastic material may be halogenated in addition to there being a flame retardant material present, or the virgin thermoplastic material may be halogenated and used by itself. Where halogenated flame retardants are present, the flame retardant is desirably present in a flame retardant amount, which can vary depending on the other components which are present. For example, the halogenated flame retardant where present in addition to the flame retardant material may be present in about 0.1 weight percent to about 40 weight percent (based on the weight of the prepreg), more particularly about 0.1 weight percent to about 15 weight percent, e.g., about 5 weight percent to about 15 weight percent. If desired, two different halogenated flame retardants may be added to the core layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the core layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 40 weight percent (based on the weight of the prepreg), more particularly about 5 weight percent to about 40 weight percent, e.g., about 5 weight percent to about 15 weight percent based on the weight of the core layer. If desired, two different substantially halogen free flame retardants may be added to the core layers. In certain instances, the core layers described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 40 weight percent (based on the weight of the prepreg or core), more particularly about 5 weight percent to about 40 weight percent, e.g., about 2 weight percent to about 14 weight percent based on the weight of the core layer. The flame retardant agents used in the core layers described herein can be added to the mixture comprising the thermoplastic material and fibers (prior to disposal of the mixture on a wire screen or other processing component) or can be added after the core layer is formed. If desired, aluminum hydroxide, magnesium hydroxide or expandable graphite materials can be present in the core layer.

In some examples, a composite article can be formed using the core layer by disposing a skin layer on one or more surfaces of the core layer. Referring to FIG. 17C, a composite article 1702 is shown that comprises a skin layer 1760 disposed on a core layer comprising a central area 1710 and an edge 1720. For example, the layer 1760 may comprise, for example, a scrim (e.g., fiber based scrim), a foil, a woven fabric, a non-woven fabric or be present as an inorganic coating, an organic coating, or a thermoset coating disposed on the core layer. In other instances, the layer 1760 may comprise a limiting oxygen index greater than about 22, as measured per ISO 4589 dated 1996. Where a fiber based scrim is present as (or as part of) the layer 1760, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the layer 1760, the coating may comprise at least one of unsaturated polyurethanes, vinyl esters, phenolics and epoxies. Where an inorganic coating is present as (or as part of) the layer 1760, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the layer 1760, the non-woven fabric may comprise a thermoplastic material, a thermal setting binder, inorganic fibers, metal fibers, metallized inorganic fibers and metallized synthetic fibers. If desired, an intermediate layer (not shown) can be present between the core layer and the skin layer 1760. In other examples, no adhesive layer or intermediate layer is present between the skin 1760 and the core. In some examples, the thickness across the composite article 1702 can be constant or substantially uniform. In some embodiments, the skin layer 1760 may be a water repellent scrim, e.g., one with a grade repellency of at least 6 or 6 or 8 as tested under ISO 23232:2009.

In some examples, a composite article may also comprise a second skin layer disposed on another surface of a core layer. Referring to FIG. 17D, a composite article 1703 is shown comprising skin layers 1760, 1770. The layer 1770 may be the same or may be different than the layer 1760. In some instances, the layer 1770 may comprise, for example, a scrim (e.g., fiber based scrim), a foil, a woven fabric, a non-woven fabric or be present as an inorganic coating, an organic coating, or a thermoset coating disposed on the core layer. In other instances, the layer 1770 may comprise a limiting oxygen index greater than about 22, as measured per ISO 4589 dated 1996. Where a fiber based scrim is present as (or as part of) the layer 1770, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the layer 1770, the coating may comprise at least one of unsaturated polyurethanes, vinyl esters, phenolics and epoxies. Where an inorganic coating is present as (or as part of) the layer 1770, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the layer 1770, the non-woven fabric may comprise a thermoplastic material, a thermal setting binder, inorganic fibers, metal fibers, metallized inorganic fibers and metallized synthetic fibers. If desired, an intermediate layer (not shown) can be present between the core layer and the skin layer 1770. In other examples, no adhesive layer or intermediate layer is present between the skin 1770 and the core. In some examples, the thickness across the composite article 1703 can be constant or substantially uniform. In some embodiments, the skin layer 1770 may be a water repellent scrim, e.g., one with a grade repellency of at least 6 or 6 or 8 as tested under ISO 23232:2009.

In certain embodiments, the skin layers present in the composite articles described herein may also comprise a variable basis weight. For example and referring to FIG. 17E, a composite article 1704 is shown that comprises a skin layer with areas 1782, 1784 of a different basis weight. In certain instances, an average basis weight of the area 1784 can be less than an average basis weight of the area 1782. While not shown, another skin layer with a variable basis weight can be present on an opposite surface of the core layer shown in FIG. 17E if desired. The basis weight at the area 1784 may be, for example, at least 5% less, at least 10% less or at least 20% less than an average basis weight of the area 1782. In other instances, the basis weight at the area 1784 may be, for example, at least 5% greater, at least 10% greater or at least 20% greater than an average basis weight of the area 1782. In some examples, the thickness across the composite article 1704 can be constant or substantially uniform.

In some examples, the composite articles described herein may comprise an additional layer disposed one or more of the skin layers. Referring to FIG. 17F, a composite article 1705 is shown comprising an additional layer 1790 disposed on the skin layer 1760. The additional layer 1790 may be another skin layer or may comprise different layers or materials. For example, the additional layer 1790 may be configured as a decorative layer, textured layer, colored layer, aluminum or other metal layer and the like. For example, a decorative layer may be formed, e.g., from a thermoplastic film of polyvinyl chloride, polyolefins, thermoplastic polyesters, thermoplastic elastomers, or the like. The decorative layer may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer may also be produced using spunbond, thermal bonded, spun lace, melt-blown, wet-laid, and/or dry-laid processes. Insulation or sound absorption layers may also be bonded to one or more surfaces of the articles described herein, and the insulation or sound absorption layers may be open or closed, e.g., an open cell foam or a closed cell foam, as desired. In the case of recreational vehicle panels, the layer 1790 may be an exterior wall panel, e.g., an aluminum panel, gel coat panel, a wall or other materials, that are on external surface of the recreational vehicle. In some examples, the thickness across the composite article 1705 can be constant or substantially uniform.

In certain embodiments, the core layers and/or articles described herein can be generally prepared using the reinforcing fibers and a thermoplastic material optionally in combination with a flame retardant material or other materials. To produce the core layer, a thermoplastic material, reinforcing fibers and optionally other materials can be added or metered into a dispersing foam contained in an open top mixing tank fitted with an impeller. Without wishing to be bound by any particular theory, the presence of trapped pockets of air of the foam can assist in dispersing the reinforcing fibers, the thermoplastic material and any other materials. In some examples, the dispersed mixture of fibers and thermoplastic can be pumped to a head-box located above a wire section of a paper machine via a distribution manifold. The foam, not the fibers, or thermoplastic, can then be removed as the dispersed mixture is provided to a moving support such as a wire screen using a pressure, continuously producing a uniform, fibrous wet web. As discussed in more detail below, in some instances the exact configuration of the moving support and/or the pressure used can be selected to provide a core layer with a variable basis weight. The wet web can be passed through a dryer at a suitable temperature to reduce moisture content and to melt or soften the thermoplastic material. When the hot web exits the dryer, a surface layer such as, for example, a textured film may be laminated onto the web by passing the web of reinforcing fiber, thermoplastic material and textured film through the nip of a set of heated rollers. If desired, additional layers such as, for example, another film layer, scrim layer, etc. may also be attached along with the textured film to one side or to both sides of the web to facilitate ease of handling the produced composite. The composite can then be passed through tension rolls and continuously cut (guillotined) into the desired size for later forming into an end composite article. Further information concerning the preparation of such composites, including suitable materials and processing conditions used in forming such composites, are described, for example, in U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US2005/0228108, US 2005/0217932, US 2005/0215698, US 2005/0164023, and US 2005/0161865. In some examples, one or more pairs of nip rollers (optionally heated nip rollers) can be used to compress the composite article to a constant or substantially uniform thickness across the width of the composite article, e.g., the cross-direction may comprise a constant or substantially uniform thickness.

In some embodiments, a positive pressure can be provided to certain areas of the moving support to force out the foam from certain areas of the moving support to leave behind increased amounts of reinforcing fibers and/or thermoplastic material. An illustration is shown in FIG. 18 where an air head 1810 is shown positioned above a portion of a support element 1805. The air head 1810 can be fluidically coupled to an air source, e.g., ambient air, an inert gas such a nitrogen or carbon dioxide, etc. to provide a positive pressure to a surface of the moving support 1805. A plurality of different air nozzles or jets may be present in the air head 1810 to provide the air to the surface of the support 1805. The edges of the moving support generally do not receive any air and have increased amounts of foam or liquid occupying the volume of the moving support 1805. When the core layer is dried to remove the foam or liquid, the amount of reinforcing fibers and/or thermoplastic material remaining at the edges is generally lower than what is present at the central area of the core layer. In other instance air heads can be positioned at the edges so a central area does not receive any air. When the core layer is dried to remove the foam or liquid, the amount of reinforcing fibers and/or thermoplastic material remaining at the central area is generally lower than what is present at the edges of the core layer. The exact positive pressure provided to the moving support 1805 may vary, for example, from about 1 to 10 psi. Generally, the positive pressure is high enough to force out some foam and/or liquid from the moving support 1805 but not so high to force out or displace the reinforcing fibers and/or thermoplastic materials from the moving support 1805. If desired, a positive pressure can be provided to the entire surface of the moving support, but the positive pressure may be higher at the central areas than at the edges or the central area. In addition, a transition region or zone may result in the core layer adjacent to the edges of the air head 1810 as some positive pressure is provided at the edges of the air head 1810 but not as much positive pressure as at the central region of the air head 1810. If desired, different pressures can be provided across the width of the air head 1810. In some examples, one or more pairs of nip rollers (optionally heated nip rollers) can be used to compress the composite article to a constant or substantially uniform thickness across the width of the composite article, e.g., the cross-direction may comprise a constant or substantially uniform thickness.

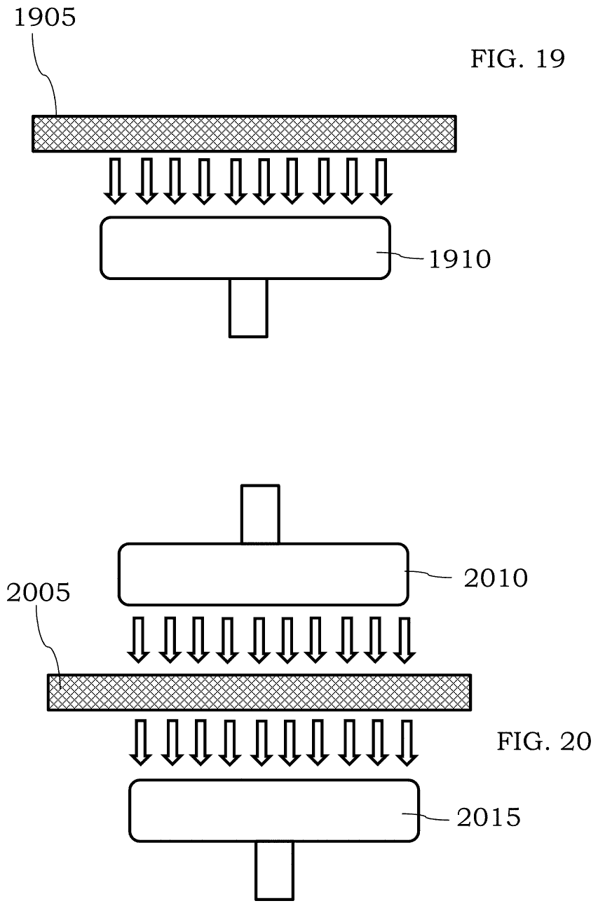

In some examples, a negative pressure can be provided to certain areas of the moving support to draw out the foam from certain areas of the moving support to leave behind increased amounts of reinforcing fibers and/or thermoplastic material. An illustration is shown in FIG. 19 where a vacuum head 1910 is shown positioned below a portion of a support element 1905. The vacuum head 1910 can be fluidically coupled to a pump to provide a negative pressure to a surface of the moving support 1905. A plurality of different ports may be present in the vacuum head 1910 to draw air and/or liquid from the surface of the support 1905. In some configurations, the edges of the moving support 1905 generally do not receive any vacuum pressure and have increased amounts of foam or liquid occupying the volume of the moving support 1905. In other configurations, the edges of the moving support 1905 do receive vacuum pressure and have decreased amounts of foam or liquid occupying the volume of the moving support 1905. The application of the differential negative pressures can provide for a variable basis weight at different areas of the core layer. The exact negative pressure provided to the moving support 1905 may vary, for example, from about 1 to 10 psi of vacuum pressure. Generally, the negative pressure is high enough to draw out some foam and/or liquid from the moving support 1905 but not so high to draw out or remove the reinforcing fibers and/or thermoplastic materials from the moving support 1905. If desired, a negative pressure can be provided to the entire surface of the moving support, but the negative pressure may be greater at the central areas than at the edges or at the edges than the central area. In addition, a transition region or zone may result in the core layer adjacent to the edges of the vacuum head 1910 as some negative pressure is provided at the edges of the vacuum head 1910 but not as much negative pressure as at the central region of the vacuum head 1910. If desired, different negative pressures can be provided across the width of the vacuum head 1910. In some examples, one or more pairs of nip rollers (optionally heated nip rollers) can be used to compress the composite article to a constant or substantially uniform thickness across the width of the composite article, e.g., the cross-direction may comprise a constant or substantially uniform thickness.

In some examples, both a positive pressure and a negative pressure can be used to provide a core layer. Referring to FIG. 20, a system is shown that includes a moving support 2005, an air head 2010 and a vacuum head 2015. The air head 2010 can be configured to provide a positive pressure to a dispersion of thermoplastic material and reinforcing fibers on the moving support 2005 to force foam and/or liquid out of the dispersion. The vacuum head 2015 can be configured to provide a negative pressure to the dispersion of thermoplastic material and reinforcing fibers on the moving support 2005 to draw out foam and/or liquid from of the dispersion. The resulting core layer generally comprises a higher basis weight at areas adjacent to the air head 2010 and the vacuum head 2015 than at other areas of the core layer. The exact absolute pressures provided by the air head 2010 and the vacuum head 2015 can be the same or can be different. In some examples, a greater negative pressure is provided than the provided positive pressure. In other examples, a greater positive pressure is provided than the provided negative pressure. In additional examples, the absolute pressure provided by the air head 2010 and the vacuum head 2015 may be about the same. In certain examples, one or more pairs of nip rollers (optionally heated nip rollers) can be used to compress the composite article to a constant or substantially uniform thickness across the width of the composite article, e.g., the cross-direction may comprise a constant or substantially uniform thickness.

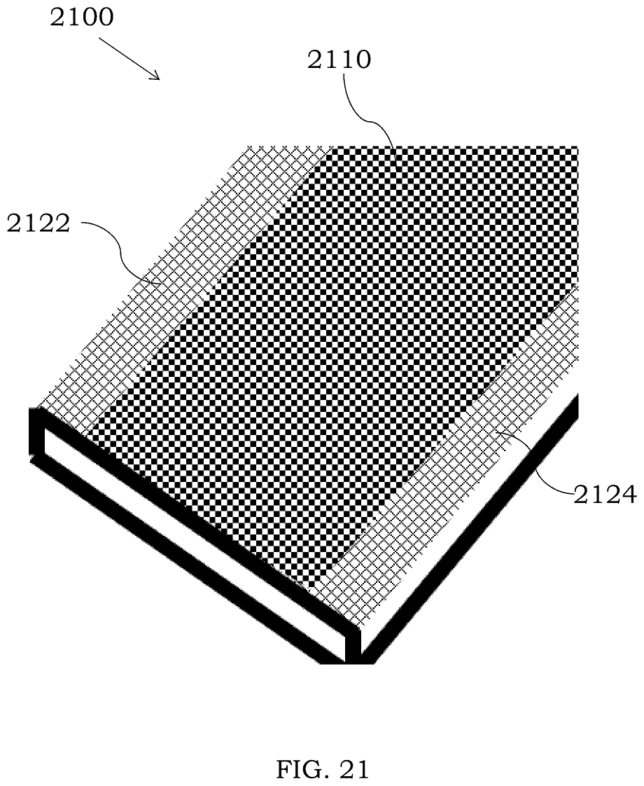

In certain embodiments, it may be desirable to use a moving support that is configured with different features, e.g., differently sized openings, different materials, etc., to provide a core layer with a variable basis weight across the width of the core layer. Referring to FIG. 21, a moving support 2100 configured as a wire screen is shown. The wire screen is configured differently at different areas 2110, 2122 and 2124. For example, the openings between wires of the screen may be smaller (on average) at area 2110 to assist in retaining more reinforcing fibers and/or thermoplastic material at the area 2110 than at the areas 2122, 2124. By selecting a mesh size of the areas 2122, 2124 to on average be greater than a mesh size 2110, lesser amounts of reinforcing fiber and/or thermoplastic material can be retained at the edges 2122, 2124 of the moving support 2100. When the foam and/or any liquid is removed from the dispersion remaining on the moving support 2100, an average basis weight at a central area of the core layer can be higher than an average basis weight at the edges. If desired, the mesh size can be smaller at the edges 2122, 2124 to increase an amount of reinforcing fibers and/or thermoplastic material retained at the edges 2122, 2124. In some examples, one or more pairs of nip rollers (optionally heated nip rollers) can be used to compress the composite article to a constant or substantially uniform thickness across the width of the composite article, e.g., the cross-direction may comprise a constant or substantially uniform thickness.

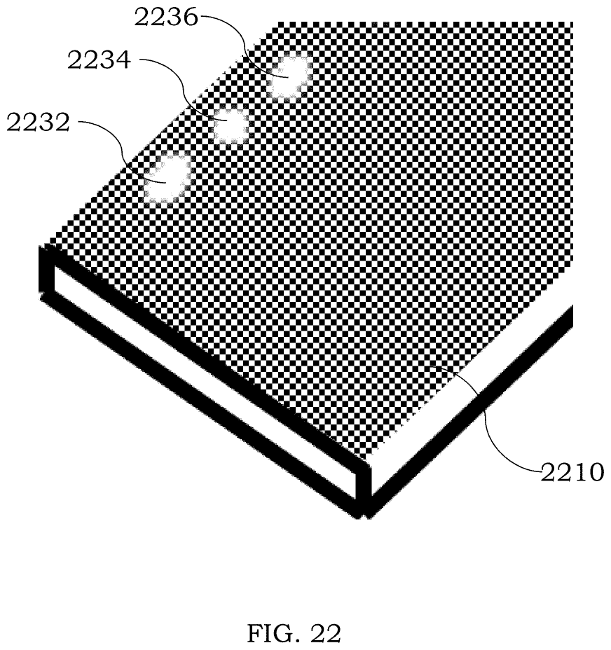

In other configurations, the moving support may comprise one or more open areas that are designed to not retain any dispersion of reinforcing fibers and/or thermoplastic materials. One illustration is shown in FIG. 22. A moving support 2210 configured as a wire screen with substantially the same mesh size comprises open areas 2232, 2234 and 2236 at edges of the moving support 2210. The open areas 2232, 2234 and 2236 generally are sized and arranged such that little or no dispersion remains in the open areas 2232, 2234 and 2236 during formation of the core layer. The presence of the open areas 2232, 2234 and 2236 generally results in a core layer with an average basis weight at an edge which is lower than an average basis weight at the center of the core layer. Alternatively, the moving support may not have any open areas and openings can be formed, e.g., drilled, cut, etched, etc. at the edge to reduce an average basis weight at the edge. In other configurations, the open areas can be present in the central area of the support element so an average basis weight of the central area is lower than that at the edges. In some examples, one or more pairs of nip rollers (optionally heated nip rollers) can be used to compress the composite article to a constant or substantially uniform thickness across the width of the composite article, e.g., the cross-direction may comprise a constant or substantially uniform thickness.

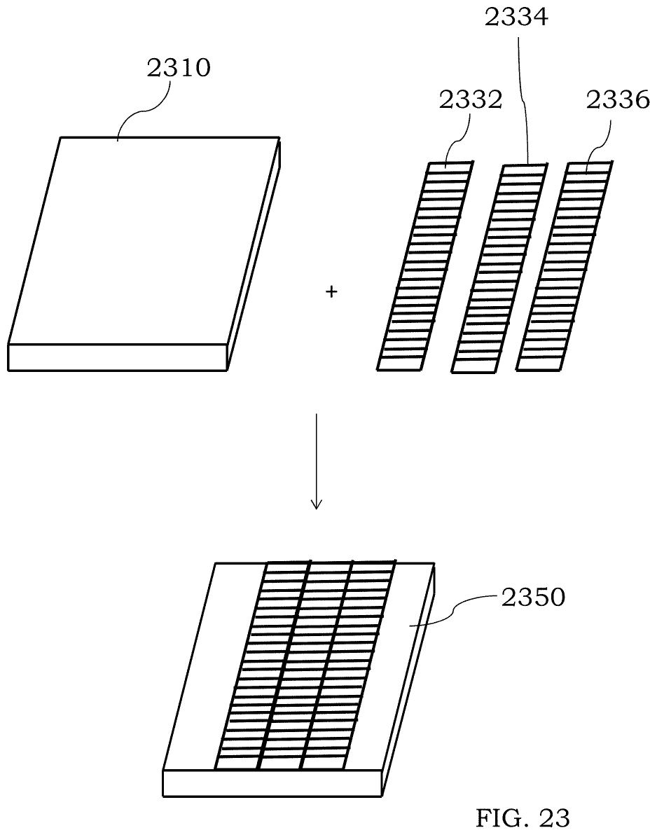

In certain embodiments, when forming a core layer, strips of material can be added to the central areas to increase an overall basis weight at those areas. The strips can be disposed during formation of the prepreg. Referring to FIG. 23, a process is schematically shown where strips 2332, 2334, 2336 of reinforcing fibers are added to a core layer 2310 to provide a core layer 2350. By adding the strips 2332, 2334, 2336, the average basis weight at a central area of the core layer 2350 is greater than an average basis weight at edges of the core layer 2350. Alternatively, the strips could instead be added at the edges so the basis weight at the edges is higher. In some examples, strips of material are added at edges of the articles when they are placed together. For example, two articles each of which comprises an edge with a lower basis weight than a central area can be positioned beside each other, and a strip of material can cover and overlap the edges to couple the two articles to each other. After coupling the strip to the two articles, the basis weight across the coupled articles can be about the same. In some examples, one or more pairs of nip rollers (optionally heated nip rollers) can be used to compress the composite article to a constant or substantially uniform thickness across the width of the composite article, e.g., the cross-direction may comprise a constant or substantially uniform thickness.

In other instances, a mask or template can be used to selectively guide deposition of the dispersion into the moving support. For example, a mask can be deposited on an outer edge of the moving support (or at a central area) to shield these areas from receiving the dispersion and/or to reduce the amount of material which can be loaded into the moving support for at least some period. The mask can then be removed prior to further processing of the core layer to provide a core layer with a lower basis weight at the edges than at a central area. In some examples, one or more pairs of nip rollers (optionally heated nip rollers) can be used to compress the composite article to a constant or substantially uniform thickness across the width of the composite article, e.g., the cross-direction may comprise a constant or substantially uniform thickness.

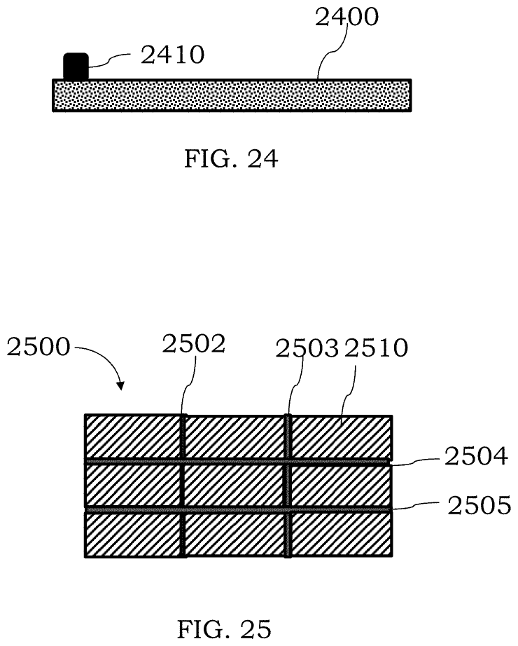

In some examples, the moving support itself may comprise bosses or projections which are designed to prevent substantially any material from being deposited at the area of the bosses or projections. Referring to FIG. 24, a side view of a support element 2400 comprising a boss 2410 that projects from a surface of the support element 2400. The boss 2410 is generally non-porous so thermoplastic material and/or reinforcing fibers do not end up at the position of the boss 2410 in the final formed prepreg or core layer. The boss 2410 is designed so open space is present at edges of the prepreg or core layer to reduce an average basis weight at the edges. Two more bosses or other features may be present on the support element 2400 and positioned as desired. In some examples, one or more pairs of nip rollers (optionally heated nip rollers) can be used to compress the composite article to a constant or substantially uniform thickness across the width of the composite article, e.g., the cross-direction may comprise a constant or substantially uniform thickness.

In certain examples, the core layers described herein can be used in composite articles configured for interior use in recreational vehicle panels, wall panels, building panels, roofs, flooring or other applications. As noted herein, the composite articles are generally used in an as-produced state and are not molded. In certain examples, the articles described herein can be configured as a ceiling tile. Referring to FIG. 25, a grid of ceiling tiles 2500 is shown that comprises support structures 2502, 2503, 2504 and 2505 with a plurality of ceiling tiles, such as tile 2510, laid into the grid formed by the support structures. In some examples, the ceiling tile comprises a porous core layer comprising a web of open celled structures comprising a random arrangement of a plurality of reinforcing fibers held together by a thermoplastic material, wherein the porous core layer comprises a flame retardant agent and an areal or basis weight of at least 2000 gsm or at least 2100 gsm or at least 2200 gsm or at least 2300 gsm or at least 2400 gsm or at least 2500 gsm. In some examples, an edge of a ceiling tile may comprise a lower basis weight than a central area of the ceiling tile. In other examples, an edge of a ceiling tile may comprise a higher basis weight than a central area of the ceiling tile. In some examples, the ceiling tile may comprise a porous decorative layer disposed on the open cell skin, e.g., a fabric, cloth, or other layers. In certain instances, a flame retardant agent in the ceiling tile comprises expandable graphite particles or magnesium hydroxide or both. In further examples, the flame retardant agent can be homogeneously dispersed in the porous core layer. In some examples, the thermoplastic material comprises a polyolefin resin. In certain embodiments, the plurality of reinforcing fibers comprise glass fibers or mineral fibers or both. In some instances, the porous core layer of the ceiling tile further comprises a clay. In some examples, the ceiling tile may comprise a constant or substantially uniform thickness across one direction, e.g., the width or the length or both, of the ceiling tile.

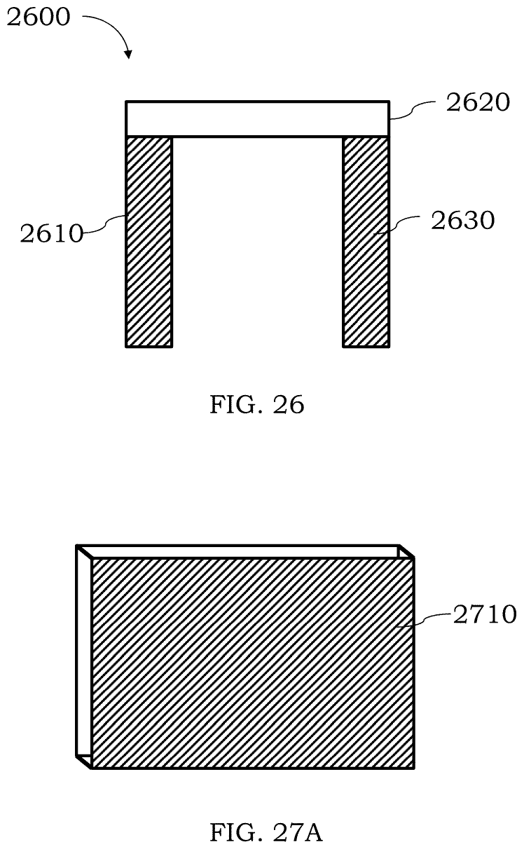

In certain examples, any one or more of the articles described herein can be configured as a cubicle panel. Referring to FIG. 26, a top view of a cubicle 2600 comprising side panels 2610, 2630 and center panel 2630 are shown. Any one or more of the panels 2610-2630 may comprise one of the porous core layers described herein. The cubicle panel may also comprise one or more skin layers. In some examples, the cubicle wall panel is sized and arranged to couple to another cubicle wall panel and comprises a porous core layer comprising a web of open celled structures comprising a random arrangement of a plurality of reinforcing fibers held together by a thermoplastic material, wherein the porous core layer comprises a flame retardant agent and an areal or basis weight of at least 2000 gsm or at least 2100 gsm or at least 2200 gsm or at least 2300 gsm or at least 2400 gsm or at least 2500 gsm. In some examples, an edge of a cubicle panel may comprise a lower basis weight than a central area of the cubicle panel. In other examples, an edge of a cubicle panel may comprise a higher basis weight than a central area of the cubicle panel. In further examples, a flame retardant agent in the cubicle wall panel comprises expandable graphite particles or magnesium hydroxide or both. In some examples, the flame retardant agent is homogeneously dispersed in the porous core layer. In other examples, the thermoplastic material comprises a polyolefin resin. In certain embodiments, the plurality of reinforcing fibers comprise glass fibers or mineral fibers or both. In some instances, the porous core layer of the cubicle wall panel further comprises a clay. In some examples, the cubicle wall may comprise a constant or substantially uniform thickness across one direction, e.g., the width or the length or both, of the cubicle wall.

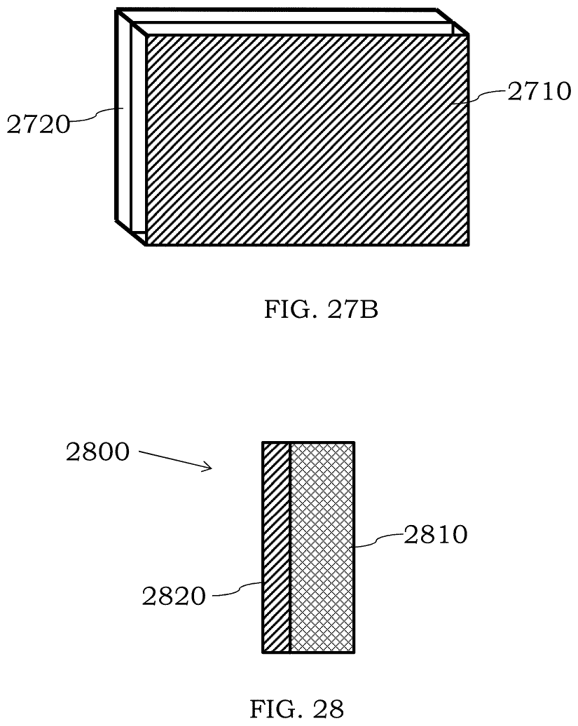

In certain embodiments, any one or more of the articles described herein can be configured as a structural panel. The structural panel can be used, for example, as sub-flooring, wall sheathing, roof sheathing, as structural support for cabinets, countertops and the like, as stair treads, as a replacement for plywood and other applications. If desired, the structural panel can be coupled to another substrate such as, for example, plywood, oriented strand board or other building panels commonly used in residential and commercial settings. Referring to FIG. 27A, a top view of a structural panel 2710 is shown. The panel 2710 may comprise any one of the core layers described herein. If desired, two or more structural panels can be sandwiched with a skin facing into the interior of the room and another skin of the other structural panel facing outward away from the interior of the room. In some instances, the structural panel may also comprise a structural substrate 2720 as shown in FIG. 27B. For example, a structural panel may comprise a porous core layer comprising a web of open celled structures comprising a random arrangement of a plurality of reinforcing fibers held together by a thermoplastic material, wherein the porous core layer comprises a flame retardant agent and an areal or basis weight of at least 2000 gsm or at least 2100 gsm or at least 2200 gsm or at least 2300 gsm or at least 2400 gsm or at least 2500 gsm. In some examples, an edge of a structural panel may comprise a lower basis weight than a central area of the structural panel. In other examples, an edge of a structural panel may comprise a higher basis weight than a central area of the structural panel. The exact nature of the structural substrate 2720 may vary and includes, but is not limited to, plywood, gypsum board, wood planks, wood tiles, cement board, oriented strand board, polymeric or vinyl or plastic panels and the like. In some examples, the structural substrate comprises a plywood panel, a gypsum board, a wood tile, a ceramic tile, a metal tile, a wood panel, a concrete panel, a concrete board or a brick. In other examples, a flame retardant agent may be present and may comprise, for example, expandable graphite particles or magnesium hydroxide or both. In some examples, the flame retardant agent is homogeneously dispersed in the porous core layer. In some embodiments, the thermoplastic material comprises a polyolefin resin and the plurality of reinforcing fibers comprise glass fibers or mineral fibers or both. If desired, the structural panel may further comprise a second structural panel coupled to a skin layer of the first structural panel, wherein the second structural panel is a porous structural panel. In some examples, the structural panel may comprise a constant or substantially uniform thickness across one direction, e.g., the width or the length or both, of the structural panel.

In certain instances, any one or more of the articles described herein can be configured as a wall board or wall panel. The wall panel can be used, for example, to cover studs or structural members in a building, to cover ceiling joists or trusses and the like. If desired, the wall panel can be coupled to another substrate such as, for example, tile, wood paneling, gypsum, concrete backer board, or other wall panel substrates commonly used in residential and commercial settings. Referring to FIG. 28, a side view of a wall panel 2800 is shown. The panel 2800 may comprise one of the porous core layers described herein. As noted herein, the panel may also comprise one or more skins on its surface. If desired, two or more wall panels can be sandwiched with one open cell skin facing into the interior of the room and the open cell skin of the other wall panel facing outward away from the interior of the room. In some examples, the wall panel 2800 may comprise a constant or substantially uniform thickness across one direction, e.g., the width or the length or both, of the wall panel. In some instances, the wall panel 2800 comprises a porous core layer 2810 comprising a web of open celled structures comprising a random arrangement of a plurality of reinforcing fibers held together by a thermoplastic material, wherein the porous core layer comprises a flame retardant agent and an areal or basis weight of at least 2000 gsm or at least 2100 gsm or at least 2200 gsm or at least 2300 gsm or at least 2400 gsm or at least 2500 gsm. The wall panel 2800 may also comprise at least one skin 2820 coupled to a first surface of the porous core layer 2810. While not shown, a second skin may be placed on a second surface of the core layer 2810. As noted herein, an optional wall substrate can be coupled to a second surface of the porous core layer 2810 and configured to support the porous core layer 2810 when the wall panel 2800 is coupled to a wall surface. In some examples, the wall panel comprises a flame spread index of less than 25 and a smoke development index of less than 150 as tested by ASTM E84 dated 2009. In certain configurations, the wall panel 2800 further comprises a porous decorative layer disposed on the open cell skin 2820. In other examples, a flame retardant agent is present and comprises expandable graphite particles or magnesium hydroxide or both. In some examples, the thermoplastic material of the wall panel 2800 comprises a polyolefin resin and the plurality of reinforcing fibers comprise glass fibers or mineral fibers or both. In certain embodiments, a second wall panel can be coupled to the skin 2820, wherein the second wall panel is a porous wall panel.

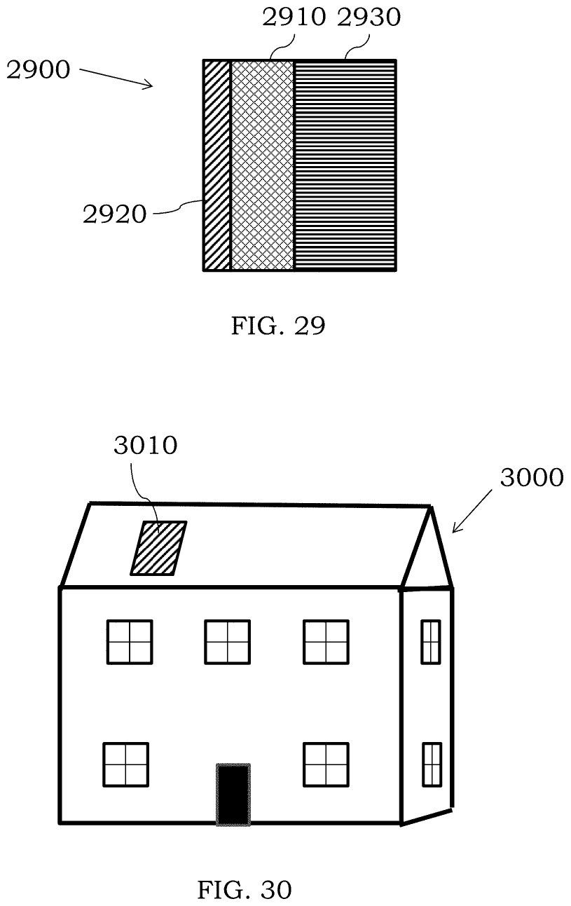

In certain instances, any one or more of the core layers or articles described herein can be configured as a siding panel to be attached to a building such as a residential home or a commercial building. The siding panel can be used, for example, to cover house wrap, sheathing or other materials commonly used on outer surfaces of a building. If desired, the siding panel can be coupled to another substrate such as, for example, vinyl, concrete boards, wood siding, bricks or other substrates commonly placed on the outside of buildings. Referring to FIG. 29, a side view of a siding panel 2900 is shown. The panel 2900 may comprise any one of the core layers or articles described herein. If desired, two or more siding panels can be sandwiched with one open cell skin facing into the interior of the building and the open cell skin of the other wall panel facing outward away from the interior of the building. In some examples, the siding panel 2900 may comprise a constant or substantially uniform thickness across one direction, e.g., the width or the length or both, of the wall panel. In some examples, the siding panel may be configured with a flame retardant. For example, the flame retardant may be present in the porous core layer 2910 comprising a web of open celled structures comprising a random arrangement of a plurality of reinforcing fibers held together by a thermoplastic material, wherein the porous core layer comprises a flame retardant agent and an areal or basis weight of at least 2000 gsm or at least 2100 gsm or at least 2200 gsm or at least 2300 gsm or at least 2400 gsm or at least 2500 gsm. In some examples, the siding panel 2900 comprises a flame spread index of less than 25 and a smoke development index of less than 150 as tested by ASTM E84 dated 2009. The substrate 2930 can be configured with many different materials including, but not limited to vinyl, wood, brick, concrete, etc. For example, a vinyl substrate can be coupled to a first surface of the flame retardant and noise reducing layer, and the siding can be configured to couple to a non-horizontal surface of a building to retain the siding panel to the non-horizontal surface of the building. In some instances, the siding panel further comprises a weather barrier, e.g., house wrap, a membrane, etc. coupled to a second surface of the flame retardant and noise reducing layer. In some embodiments, the substrate comprises a nailing flange to permit coupling of the siding to the side of the building. In some examples, the flame retardant agent is homogeneously dispersed in the porous core layer. In other examples, the thermoplastic material comprises a polyolefin resin and the plurality of reinforcing fibers comprise glass fibers or mineral fibers or both. In some examples, the siding panel may further comprise a second siding panel comprising a second flame retardant and can be coupled to a second substrate. In some cases, a butt joint, overlapping joint, etc. may exist where the two siding panels can horizontally lock into each other.

In certain instances, any one or more of the core layers or articles described herein can be configured as a roofing panel to be attached to a building such as a residential home or a commercial building to absorb sound and to provide flame retardancy. The roofing panel can be used, for example, to cover an attic space, attach to roof trusses or cover a flat roof as commonly present in commercial buildings. If desired, the roofing panel can be coupled to another substrate such as, for example, oriented strand board, plywood, or even solar cells that attach to a roof and function to cover the roof. Referring to FIG. 30, a perspective view of a roofing panel 3010 attached to a house 3000 is shown. The roofing panel 3010 may comprise any one of the core layers or articles described herein. If desired, two or more roofing panels can be sandwiched or otherwise used together. In some examples, the roofing panel 3000 may comprise a constant or substantially uniform thickness across one direction, e.g., the width or the length or both, of the roofing panel. In some examples, the roofing panel comprises a flame retardant and is coupled to a roofing substrate. In certain examples, the flame retardant is present in the porous core layer comprising a web of open celled structures comprising a random arrangement of a plurality of reinforcing fibers held together by a thermoplastic material, wherein the porous core layer comprises a flame retardant agent and an areal or basis weight of at least 2000 gsm or at least 2100 gsm or at least 2200 gsm or at least 2300 gsm or at least 2400 gsm or at least 2500 gsm. If desired, the roofing panel may comprise a flame spread index of less than 25 and a smoke development index of less than 150 as tested by ASTM E84 dated 2009. The roofing panel may also comprise a roofing substrate coupled to a first surface of the flame retardant core layer and can be coupled to a roof of a building to retain the roofing panel to the roof. In some examples, the roofing panel may comprise or be used with a weather barrier, e.g., a membrane, house wrap, tar paper, plastic film, etc. In other instances, the roofing substrate comprises a cellulose-based material. In other examples, the flame retardant agent in the roofing panel may comprise expandable graphite particles or magnesium hydroxide or both. In some instances, the flame retardant agent is homogeneously dispersed in the porous core layer. In other examples, the thermoplastic material comprises a polyolefin resin and the plurality of reinforcing fibers comprise glass fibers or mineral fibers or both. In certain instances, the roofing panel comprises a second roofing panel or can be overlapped with, or coupled to, a second roofing panel to prevent moisture from entering into the house 3000.

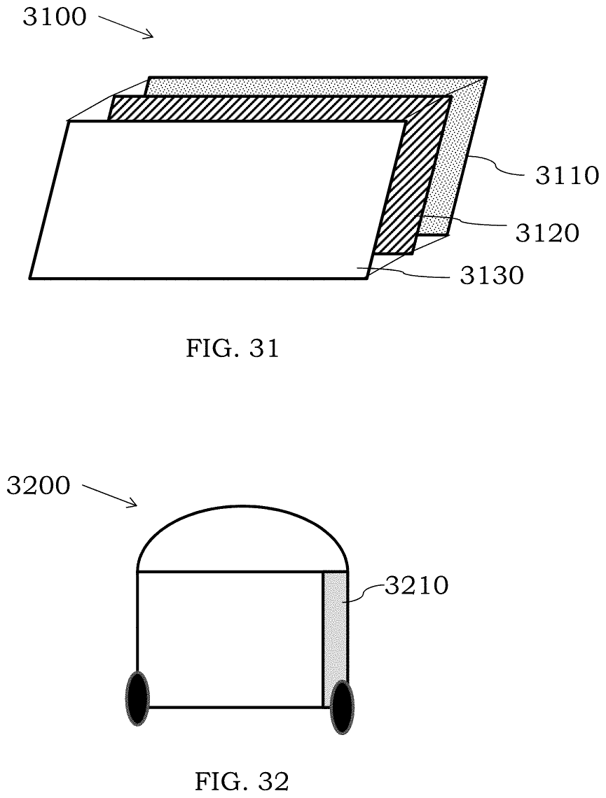

In certain configurations, any one or more of the core layers or articles described herein can be configured as a roofing shingle to be attached to a building such as a residential home or a commercial building to absorb sound and to provide flame retardancy. The roofing shingle can be used, for example, to cover a roof commonly present in residential and commercial buildings. If desired, the roofing shingle can be coupled to another substrate such as, for example, asphalt, ceramic, clay tile, aluminum, copper, wood such as cedar and other materials commonly found or used as roofing shingles Referring to FIG. 31, an exploded view of a roofing shingle 3100 is shown. The roofing shingle 3100 may comprise any one of the core layers or articles described herein. If desired, two or more roofing shingles can be sandwiched. In some examples, the roofing shingle 3100 may comprise a constant or substantially uniform thickness across one direction, e.g., the width or the length or both, of the roofing shingle. In certain examples, the roofing panel 3100 may comprise a flame retardant material in the porous core layer 3110 comprising a web of open celled structures comprising a random arrangement of a plurality of reinforcing fibers held together by a thermoplastic material, wherein the porous core layer comprises a flame retardant agent and an areal or basis weight of at least 2000 gsm or at least 2100 gsm or at least 2200 gsm or at least 2300 gsm or at least 2400 gsm or at least 2500 gsm. In some examples, the roofing panel may comprise a flame spread index of less than 25 and a smoke development index of less than 150 as tested by ASTM E84 dated 2009. A weatherproof roofing shingle substrate 3130 can be coupled to a first surface of the article and configured to couple to a roofing panel of a building to provide a weatherproof and flame retardant roofing panel. In certain instances, a weather barrier can be coupled to a roofing shingle. In other examples, the roofing shingle comprises asphalt. In certain examples, the flame retardant agent comprises expandable graphite particles or magnesium hydroxide or both. In other examples, the flame retardant agent is homogeneously dispersed in the porous core layer. In certain embodiments, the thermoplastic material comprises a polyolefin resin and the plurality of reinforcing fibers comprise glass fibers or mineral fibers or both. In some examples, the roofing shingle comprises a second roofing shingle which can overlap or be coupled to the roofing shingle. An intermediate layer 3120, e.g., insulation or other materials, can be present between the outer layer 3130 and substrate 3110.

In certain configurations, any one or more of the core layers or articles described herein can be configured as an interior panel or wall of a recreational vehicle (RV). The panel or wall can be used, for example, to cover a skeleton structure on an interior side of the recreational vehicle and may be coupled to foam or other insulation materials between the interior and exterior of the recreational vehicle. In some examples, the core layer or article may be part of a sandwich structure formed from the core layer or article and other layers. If desired, the RV interior panel can be coupled to another substrate such as, for example, a fabric, plastic, tile, etc. Referring to FIG. 32 a side view of a recreational vehicle 3200 is shown. The interior panel 3210 may comprise any one of the core layers or articles described herein. If desired, two or more RV panels can be sandwiched or coupled together. In some examples, the RV panel 3210 may comprise a constant or substantially uniform thickness across one direction, e.g., the width or the length or both, of the RV panel. In certain examples, a RV interior panel comprises a flame retardant in a porous core layer comprising a web of open celled structures comprising a random arrangement of a plurality of reinforcing fibers held together by a thermoplastic material, wherein the porous core layer comprises a flame retardant agent and an areal or basis weight of at least 2000 gsm or at least 2100 gsm or at least 2200 gsm or at least 2300 gsm or at least 2400 gsm or at least 2500 gsm. In some examples, the RV panel comprises a flame spread index of less than 25 and a smoke development index of less than 150 as tested by ASTM E84 dated 2009. In some examples, RV panel may comprise an interior wall substrate that is configured as a decorative layer such as a fabric, a plastic, tile, metal, wood or the like. In other instances, the flame retardant agent comprises expandable graphite particles or magnesium hydroxide or both. In certain examples, the flame retardant agent is homogeneously dispersed in the porous core layer. In some embodiments, the thermoplastic material comprises a polyolefin resin and the plurality of reinforcing fibers comprise glass fibers or mineral fibers or both. In additional instances, the RV panel comprises a second RV interior panel which can be the same or different from the RV panel. If desired, the RV panel may comprise a third RV interior panel which may also be the same or different. In some instances, edges of the RV panels with a lower basis weight can be positioned to vertically overlap or be adjacent to each other. In other instances, edges of the RV panels with a lower basis weight can be positioned to horizontally overlap or be adjacent to each other. Where the edges are adjacent to each other, a skin or other material may be placed on the edges to create a barrier between the edges. If desired, the edges of the RV interior panel could instead have a higher basis weight than a central area of the RV interior panel.

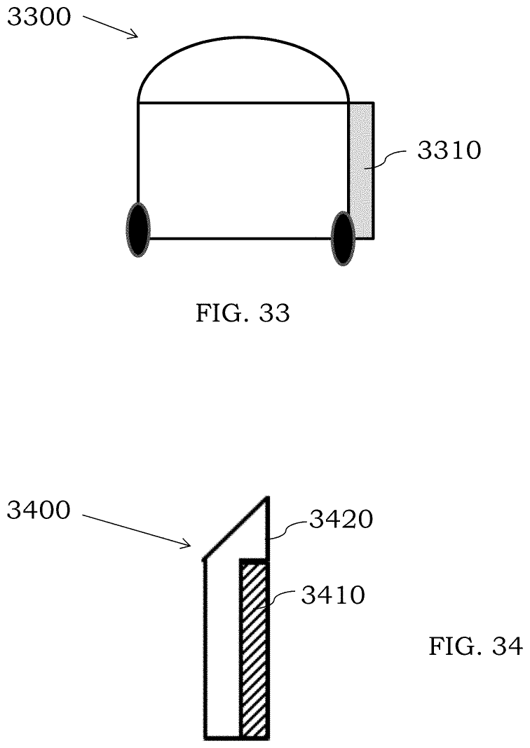

In certain configurations, any one or more of the core layers or articles described herein, can be configured as an exterior panel or wall of a recreational vehicle (RV). The panel or wall can be used, for example, to cover a skeleton structure on an exterior side of the recreational vehicle and may be coupled to foam or other insulation materials between the interior and exterior of the recreational vehicle. In some examples, the core layer or article may be part of a sandwich structure formed from the core layer or article and other layers. If desired, the RV exterior panel can be coupled to another substrate such as, for example, a metal, fiberglass, etc. Referring to FIG. 33, a side view of a recreational vehicle 3300 is shown that comprises an exterior panel 3310, which can be configured as any one of the core layers or articles described herein. If desired, two or more RV panels can be sandwiched with one open cell skin facing into the interior of the RV and the open cell skin of the other RV panel facing outward away from the interior of the RV. In some examples, the RV panel 3310 may comprise a constant or substantially uniform thickness across one direction, e.g., the width or the length or both, of the RV panel. In some examples, a RV exterior panel comprises a flame retardant in a porous core layer comprising a web of open celled structures comprising a random arrangement of a plurality of reinforcing fibers held together by a thermoplastic material, wherein the porous core layer comprises a flame retardant agent and an areal or basis weight of at least 2000 gsm or at least 2100 gsm or at least 2200 gsm or at least 2300 gsm or at least 2400 gsm or at least 2500 gsm. In some instances, the RV exterior panel comprises a flame spread index of less than 25 and a smoke development index of less than 150 as tested by ASTM E84 dated 2009. In certain configurations, the exterior wall substrate comprises glass fibers or is configured as a metal panel such as aluminum or other metal materials. In other examples, the flame retardant agent comprises expandable graphite particles or magnesium hydroxide or both. In certain instances, the flame retardant agent is homogeneously dispersed in the porous core layer. In some examples, the thermoplastic material comprises a polyolefin resin and the plurality of reinforcing fibers comprise glass fibers or mineral fibers or both. In additional instances, the RV panel comprises a second RV exterior panel which can be the same or different from the RV panel. If desired, the RV panel may comprise a third RV exterior panel which may also be the same or different. In some instances, edges of the RV panels with a lower basis weight can be positioned to vertically overlap or be adjacent to each other. In other instances, edges of the RV panels with a lower basis weight can be positioned to horizontally overlap or be adjacent to each other. Where the edges are adjacent to each other, a skin or other material may be placed on the edges to create a barrier between the edges. If desired, the edges of the RV exterior panel could instead have a higher basis weight than a central area of the RV exterior panel.

In some examples, similar constructs can be used as interior trim applications, e.g., RV interior trim, interior trim for building or for automotive applications. For example, an interior trim comprising a flame retardant material in a porous core layer comprising a web of open celled structures comprising a random arrangement of a plurality of reinforcing fibers held together by a thermoplastic material, wherein the porous core layer comprises a flame retardant agent and an areal or basis weight of at least 2000 gsm or at least 2100 gsm or at least 2200 gsm or at least 2300 gsm or at least 2400 gsm or at least 2500 gsm. In some examples, the trim comprises a flame spread index of less than 25 and a smoke development index of less than 150 as tested by ASTM E84 dated 2009. The interior trim substrate can be coupled to other materials, such as, for example, wood, PVC, vinyl, plastic, leather or other materials. A side view illustration of a trim piece that can be used as baseboard trim is shown in FIG. 34. The trim piece 3400 comprises a trim substrate 3420 which may comprise a variable basis weight and a constant or substantially uniform thickness in at least one direction. The trim piece 3400 may be nailed or otherwise attached to a stud or wallboard 3410 as desired. The substrate 3420 faces outward and is viewable within a room. The trim piece 3400 can be curved or may take two or three dimensional shapes as desired.

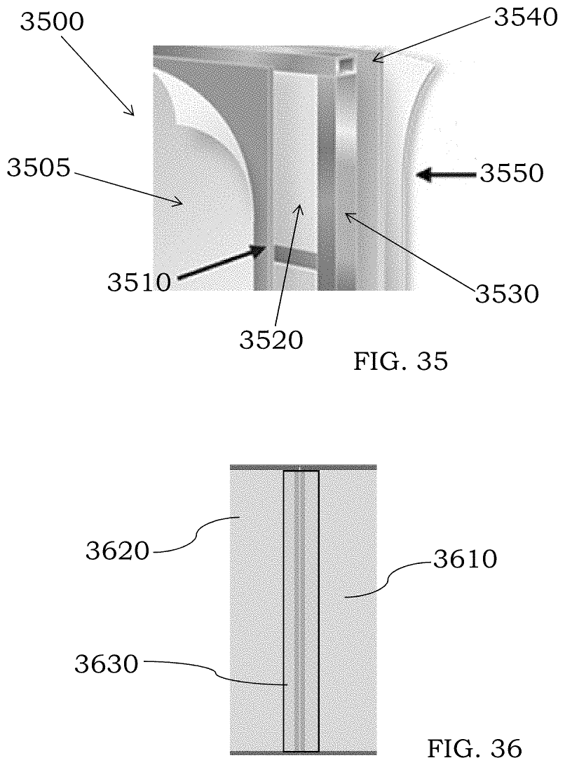

In some embodiments, the core layer or articles described herein may be present in a grid or other pattern with a RV wall. Referring to FIG. 35, a sandwich panel construct of a RV wall is shown. The RV wall 3500 comprises an exterior substrate 3505 such as a fiberglass panel (FRP), a composite article 3510 comprising a porous core layer and a skin layer on each surface of the core layer, insulation layer 3520, wall structure or skeleton 3530, an interior wall panel 3540 and a decorative panel 3550. The interior wall panel 3540 may take many different forms including a wood panel, a Luan panel, a plastic panel, or panels comprising other materials. The decorative panel 3350 may comprise a fabric material, plastic material, paper material or other materials. As shown in more detail in FIG. 36, the composite articles described herein may be stacked or positioned adjacent to each other as articles 3610, 3620 and a material 3630 can be added on top of the gaps to provide a continuous layer of material. Where panels 3610, 3620 have a lower basis weight at the edges, seam read through to other layers of the sandwich structure can be reduced or avoided. The exact material used to join or couple the panels 3610, 3620 to each other may vary and includes metals, papers, strips of material comprising a porous core layer and skins on each surface and other materials. In some examples, the core layer or articles described herein may comprise be used in an RV wall without any seams showing from where two or more of the core layers or articles meet.

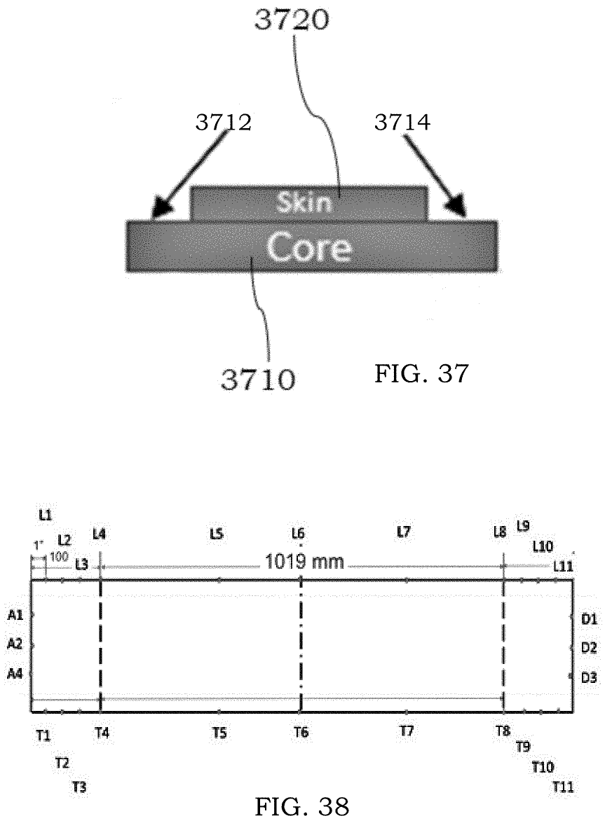

In some embodiments, the articles described herein can be used to reduce seam read through on exterior surfaces of the RV. Referring to FIG. 37, if desired, the composite article may comprise a core layer 3710 with a skin layer 3720 on a surface. As shown in FIG. 37, the skin layer 3720 does not span across an entire surface of the porous core layer 3710. Edges 3712, 3714 are bare. Edges of two or more panels can be placed beside each other and a material such as a tape can be added over the edges so a thickness across the entire RV panel is constant or substantially uniform.

Certain specific examples are described below to illustrate some of the features and aspects of the technology.

### Example 1

Two composite articles (ST-12882 and ST-12883) were produced that included a core layer comprising polypropylene resin (45 weight percent) and glass fibers (55 weight percent). Milyon scrims, each with a basis weight of about 24-26 gsm and thickness of about 0.2 mm, were added to each side of the core layer with a black Milyon scrim on the top surface and a white Milyon scrim on the bottom surface. The Milyon scrims are water repellent scrims as measured under ISO 23232:2009 and have a repellency grade of 8.

Various analytical properties were measured for the ST-12882 and ST-12883 test articles including basis weight and thickness from disks punched from the composite article boards. The results are shown in Table 1.

TABLE 1

| | Basis weight (gsm) | | Thickness (mm) | |
|---|---|---|---|---|
| Sample | Edges | Center | Edges | Center |
| ST-12882 | 878 ± 20 | 1014 ± 6 | 2.72 ± 0.20 | 2.89 ± 0.06 |
| ST-12883 | 1268 ± 4 | 1006 ± 20 | 2.89 ± 0.05 | 2.69 ± 0.05 |

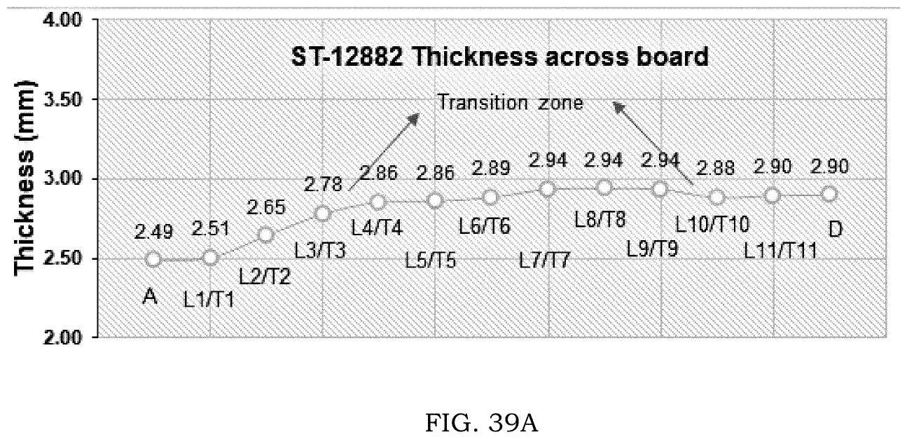

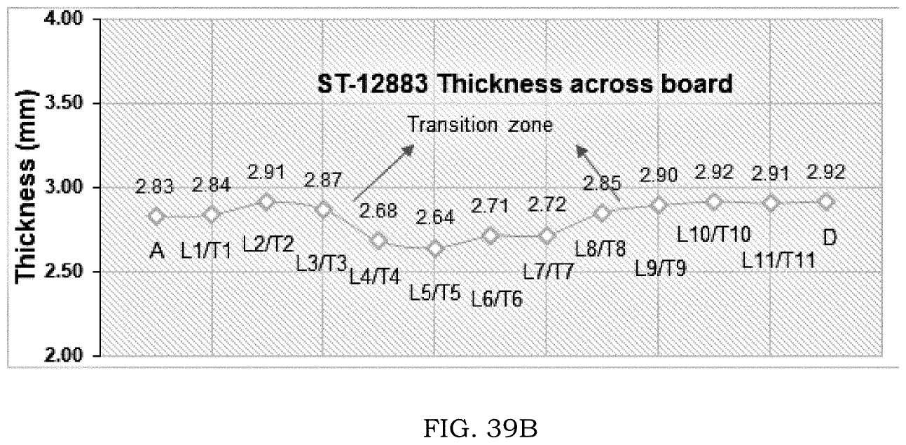

The various areas of each board used to measure the thickness are shown in FIG. 38. The edge thickness was averaged from measurements at fourteen different areas (L1, T1, L2, T2, L10, L11, T11, A1, A2, A3, D1, D2 and D3) along the edges of each board. The center measurements were averaged from six different measurements (L5, T5, L6, T6, L7 and T7) along the center of each board. The aisle edge of the board is along the L1-L4 values in FIG. 38, and the drive edge of the board is along the L8-L11 values in FIG. 38. The cross direction of the board is the direction from A1, A2 and A3 to D1, D2 and D3. The thickness profile for each tested article is shown in FIGS. 39A (ST-12882) and 39B (ST-12883). The edge thickness and center thickness differed by about 6% for the ST-12882 article, even though the basis weight of the article at the edges was over 13% less than at the center. The edge thickness and center thickness differed by about 7% for the ST-12882 article even though the basis weight of the article at the edges was over 20% higher than at the center.

Ash content and density of the test articles was also measured. The results are shown in Table 2.

TABLE 2

| | Ash (%) | | Density (g/cm³) | |
|---|---|---|---|---|
| Sample | Edges | Center | Edges | Center |
| ST-12882 | 52.6 ± 0.7 | 52.7 ± 0.3 | 0.29 ± 0.01 | 0.33 ± 0.00 |
| ST-12883 | 53.2 ± 0.2 | 52.6 ± 0.2 | 0.43 ± 0.00 | 0..35 ± 0.00 |

Ash content and density values were similar at the edges and center for each board. The edge width with the different basis weight was about 100 mm with a transition zone up to about 25 mm.

### Example 2

Various flexural properties were measured for each article from each surface of the board. Specimens were cut from each board at the various positions shown in FIG. 38. In Table 3 below, “(white)” refers to the white side being placed against load, and “(black)” refers to the black side being placed against the load. ASTM D790 dated 2007 was used to measure the peak load and stiffness.

TABLE 3

| | Peak Load MD (N) | | | Stiffness MD (N/cm) | | |
|---|---|---|---|---|---|---|
| | Aisle | Drive | | Aisle | Drive | |
| Sample | Edge | Edge | Center | Edge | Edge | Center |
| ST-12882 | 8.1 ± 1.1 | 11.9 ± 0.5 | 22.7 ± 1.6 | 40.3 ± 7.7 | 58.3 ± 7.0 | 112.5 ± 7.9 |
| (white) | | | | | | |
| ST-12882 | 7.3 ± 1.1 | 13.5 ± 2.1 | 23.4 ± 1.7 | 40.1 ± 5.0 | 64.0 ± 6.2 | 107.2 ± 7.2 |
| (black) | | | | | | |
| ST-12883 | 34.0 ± 4.5 | 43.9 ± 2.6 | 20.7 ± 2.1 | 138.4 ± 4.6 | 168.1 ± 9.4 | 94.4 ± 8.7 |
| (white) | | | | | | |
| ST-12883 | 32.7 ± 2.6 | 37.0 ± 2.5 | 16.5 ± 1.4 | 130.6 ± 15.2 | 157.1 ± 8.6 | 68.3 ± 6.1 |
| (black) | | | | | | |

Peak load and stiffness measurements in the cross direction are shown in Table 4.

TABLE 4

| | Peak Load CD (N) | Stiffness CD (N/cm) |
|---|---|---|
| Sample | Center | Center |
| ST-12882 (white) | 14.9 ± 0.8 | 58.3 ± 4.8 |
| ST-12882 (black) | 14.1 ± 1.5 | 53.5 ± 9.0 |
| ST-12883 (white) | 12.6 ± 0.9 | 52.1 ± 7.8 |
| ST-12883 (black) | 14.6 ± 1.0 | 51.1 ± 6.2 |

These results are consistent with the center being stiffer than the edges for the ST-12882 board and the edges being stiffer than the center for the ST-12883 boards.

### Example 3

Z-direction tensile strength measurements were performed at certain different areas of each board. The results are shown in Table 5 below.

TABLE 5

Peak load (N)

| Samples | Center | Aisle | Drive |
|---|---|---|---|
| ST- | C1: 1281 | A1: 362 | D1: 827 |
| 12882 | C2: 924 | A2: 541 | D2: 918 |
| (Lighter | C3: 1259 | A3: 952 | D3: 509 |
| edges) | C4: 1503 | A4: 503 | D4: 922 |
| | C5: 1623 | A5: 907 | D5: 983 |
| | Avg.: 1318 | Avg.: 653 | Avg.: 832 |
| | Std. dev.: 268 | Std. dev.: 262 | Std. dev.: 189 |

Aisle and Drive edges
(Avg. ± Std. dev.): 742 ± 235

| | | | |
|---|---|---|---|
| ST- | C1: 1887 | A1: 1982 | D1: 1301 |
| 12883 | C2: 1348 | A2: 2508 | D2: 1487 |
| (Heavier | C3: 1535 | A3: 1896 | D3: 1666 |
| edges) | C4: 1594 | A4: 2267 | D4: 1568 |
| | C5: 1593 | A5: 2134 | D5: 1383 |
| | Avg.: 1591 | Avg.: 2157 | Avg.: 1481 |
| | Std. dev.: 194 | Std. dev.: 242 | Std. dev.: 145 |

Aisle and Drive edges
(Avg. ± Std. dev.): 1743 ± 357

For the ST-12882 board, no significant difference between aisle and drive edges was observed. The center has higher Z-direction strength than edges. For the ST-12883 board, the tensile strength of the center is significantly different from the aisle edge but not significantly different from the drive edge. The tensile strength through the thickness at the aisle edge is higher than at the center for the ST-12883 board.

### Example 4

Compressive properties of the two boards were measured according to the ISO 14126:1999 standard. The results are shown in Tables 6 and 7.

TABLE 6

| | Compressive Peak Strength (MPa) | | |
|---|---|---|---|
| Samples | Aisle | Drive | Center |
| ST-12882 | 153 ± 4 | 124 ± 1 | 129 ± 5 |
| (Lighter edges) | | | |
| ST-12883 | 131 ± 2 | 138 ± 2 | 144 ± 5 |
| (Heavier edges) | | | |

TABLE 7

| | Stiffness (×1000) (N/cm) | | |
|---|---|---|---|
| Samples | Aisle | Drive | Center |
| ST-12882 | 381 ± 36 | 385 ± 9 | 588 ± 58 |
| (Lighter edges) | | | |
| ST-12883 | 677 ± 47 | 690 ± 20 | 573 ± 53 |
| (Heavier edges) | | | |

For the ST-12882 board, the center is stiffer than edges, because the center is heavier. For the ST-12883 board, the edges are stiffer through the thickness than the center, because the edges are denser (heavier edges but similar thickness).

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. A method of producing a recreational vehicle panel, the method comprising:
disposing a dispersion comprising a substantially homogeneous mixture of a thermoplastic material and reinforcing fibers onto a forming support element;
providing a pressure to less than an entire surface of the forming support element comprising the disposed foam to provide a porous web comprising a variable basis weight at different areas of the web;
compressing the porous web comprising the variable basis weight at different areas of the web to a substantially uniform thickness across a width of the web; and
drying the compressed web to provide a recreational vehicle panel comprising a porous core layer, wherein the recreational vehicle panel comprises a variable basis weight across a width of the porous core layer and comprises a substantially uniform thickness.

2. The method of claim 1, further comprising providing a negative pressure to an underside of the forming support element comprising the disposed dispersion.

3. The method of claim 1, further comprising providing the negative pressure to a central area of the forming support element comprising the disposed dispersion to provide the central area with a higher basis weight than at edges of the porous core layer.

4. The method of claim 1, further comprising providing the negative pressure to an edge area of the forming support element comprising the disposed dispersion to provide the edge area with a higher basis weight than at a central area of the porous core layer.

5. The method of claim 1, further comprising disposing a first skin on a first surface of the porous web prior to compressing the porous web.

6. The method of claim 5, further comprising disposing a second skin on a second surface of the porous web prior to compressing the porous web.

7. The method of claim 6, wherein at least one of the first skin and the second skin comprises a variable basis weight.

8. The method of claim 6, wherein at least one of the first skin and the second skin comprises a water repellent scrim.

9. The method of claim 6, wherein each of the first skin and the second skin comprises a water repellent scrim.

10. The method of claim 6, wherein each of the first skin layer and the second skin layer is coupled to the porous web without the use of an adhesive layer.

11. A recreational vehicle panel comprising:
a porous core layer comprising a web of open celled structures formed by the reinforcing fibers held together by the thermoplastic material, wherein the porous core layer comprises a variable basis weight across a width of the porous core layer and also comprises a substantially uniform thickness across the width of the porous core layer;
a first skin layer coupled to a first surface of the porous core layer; and
a second skin layer coupled to a second surface of the porous core layer.

12. The recreational vehicle panel of claim 11, wherein the porous core layer comprises a lower basis weight at cross direction edges than at a central area.

13. The recreational vehicle panel of claim 12, further comprising a transition zone between each of the cross direction edges and the central area, wherein a basis weight of the transition zone is variable.

14. The recreational vehicle panel of claim 13, wherein the transition zone comprises a basis weight/distance slope of greater than 0 gsm/cm and up to 100 gsm/cm.

15. The recreational vehicle panel of claim 14, wherein the basis weight/distance slope is linear from the cross direction edges to the central area.

16. The recreational vehicle panel of claim 11, wherein the reinforcing fibers comprise glass fibers.

17. The recreational vehicle panel of claim 16, wherein the thermoplastic material comprises a polyolefin material.

18. The recreational vehicle panel of claim 17, wherein at least one of the first skin layer and the second skin layer comprises a water repellent scrim.

19. The recreational vehicle panel of claim 17, wherein each of the first skin layer and the second skin layer comprises a water repellent scrim.

20. The recreational vehicle panel of claim 19, wherein each of the first skin layer and the second skin layer is coupled to the porous core layer without the use of an adhesive layer.

21-62. (canceled)
